(19) United States
(12) Patent Application Publication
(10) Pub. No.: US 2026/0172679 A1
(43) Pub. Date: Jun. 18, 2026

(54) CONTROL APPARATUS, IMAGE PICKUP APPARATUS, CONTROL METHOD, AND STORAGE MEDIUM

(71) Applicant: CANON KABUSHIKI KAISHA, Tokyo (JP)

(72) Inventor: SHUN NAKAMURA, Kanagawa (JP)

(21) Appl. No.: 19/405,604

(22) Filed: Dec. 2, 2025

(30) Foreign Application Priority Data
Dec. 16, 2024 (JP) 2024-220266

(51) Int. Cl. H04N 23/67; H04N 23/69

(52) U.S. Cl. CPC H04N 23/675; H04N 23/69

(57) ABSTRACT

Control apparatuses, image pickup apparatuses, control methods, and storage media are provided herein. One or more control apparatuses may include one or more memories storing instructions, and one or more processors that, upon execution of the instructions, operate to acquire movement information on an object, control a focus lens using focus information acquired from an imaging signal, and change processing regarding trackability in autofocus according to the movement information on the object.

### BACKGROUND

### Field of the Technology

The aspect of the disclosure relates to one or more embodiments of a control apparatus, an image pickup apparatus, a control method, and a storage medium.

### Description of the Related Art

A conventional function (full-time MF) is known that switches from autofocus (AF) to manual focus (MF) to control focusing in a case where a user performs an MF operation during AF (action). In capturing an object approaching an image pickup apparatus, the user may track the object using full-time MF, then stop the MF operation and switch to focus tracking using AF. In such a case, the object may move closer while MF is switched to AF, and the focus tracking delayed due to the switched AF.

Japanese Patent Application Laid-Open No. 2022-156874 discloses a method for changing AF after a full-time MF operation, more specifically, a method for changing which area of the screen to focus on, according to whether there is an in-focus object by the MF operation.

The method disclosed in Japanese Patent Application Laid-Open No. 2022-156874 cannot provide proper AF in a case where there are focus changes in a depth direction, such as in a case where the object moves closer to or away from the image pickup apparatus.

### SUMMARY

One or more embodiments of a control apparatus may include one or more memories storing instructions, and one or more processors that, upon execution of the instructions, operate to acquire movement information on an object, control a focus lens using focus information acquired from an imaging signal, and change processing regarding trackability in autofocus according to the movement information on the object. One or more image pickup apparatuses may include one or more control apparatuses in accordance with one or more other aspects of the disclosure. One or more control methods corresponding to the above one or more control apparatuses also constitutes another aspect of the disclosure. A storage medium storing a program that causes a computer to execute the above one or more control methods also constitutes another aspect of the disclosure.

Features of the present disclosure will become apparent from the following description of embodiments with reference to the attached drawings. The following description of embodiments will be described by way of example.

### BRIEF DESCRIPTION OF THE DRAWINGS

FIG. 1 is a block diagram of an image pickup apparatus according to first, second, and fourth embodiments.

FIGS. 2A and 2B illustrate pixel arrangement of an image sensor in each embodiment.

FIG. 3 explains the focus detection processing in each embodiment.

FIGS. 4A, 4B, and 4C illustrate a pair of image signals obtained from an AF area in each embodiment.

FIGS. 5A and 5B illustrate a relationship between a shift amount and a correlation amount of a pair of image signals in each embodiment.

FIGS. 6A and 6B illustrate a relationship between the shift amount and a correlation change amount of a pair of image signals in each embodiment.

FIG. 7 is a flowchart illustrating moving image capturing processing according to each embodiment.

FIG. 8 is a flowchart illustrating object movement detection processing according to the first, second, and fourth embodiments.

FIG. 9 is a flowchart illustrating focus drive processing according to the first and third embodiments.

FIG. 10 is a flowchart illustrating focus drive processing by AF according to each embodiment.

FIG. 11 is a flowchart illustrating AF (execution) processing according to each embodiment.

FIGS. 12A, 12B, and 12C illustrate examples of object movement detection according to each embodiment.

FIGS. 13A, 13B, 13C, and 13D explain the problems that occur in a case where each embodiment is not applied.

FIG. 14 illustrates an ideal focus position and an actual focus position for an object position in each of the scenes in FIGS. 13A, 13B, 13C, and 13D.

FIG. 15 illustrates another example of the ideal focus position and actual focus position for the object position in each of the scenes in FIGS. 13A, 13B, 13C, and 13D.

FIGS. 16A, 16B, 16C, and 16D′ illustrate an example of the effects of each embodiment.

FIG. 17 illustrates the ideal focus position and actual focus position for the object position in each of the scenes in FIGS. 16A, 16B, 16C, and 16D′.

FIG. 18 is a flowchart illustrating focus drive processing according to the second embodiment.

FIGS. 19A, 19B, and 19C illustrate an example of when it is proper to set a waiting time after a full-time MF operation and before AF processing in the second embodiment.

FIG. 20 illustrates a changing example of the actual focus position when the full-time MF operation is started and stopped in the scenes of FIGS. 19A, 19B, and 19C.

FIG. 21 illustrates an example of the ideal focus position and actual focus position for the object position in each of the scenes of FIGS. 13A, 13B, 13C, and 13D, with a waiting time after the full-time MF operation and before AF is started.

FIG. 22 is a block diagram of an image pickup apparatus according to a third embodiment.

FIG. 23 is a flowchart illustrating object movement detection processing according to the third embodiment.

FIG. 24 is a flowchart illustrating focus drive processing according to the fourth embodiment.

FIG. 25 illustrates the ideal focus position and actual focus position for the object position in a case where AF start operation is performed in each of the scenes of FIGS. 16A, 16B, 16C, and 16D′.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

First, a first embodiment according to the disclosure will be described.

### Configuration of Image Pickup Apparatus

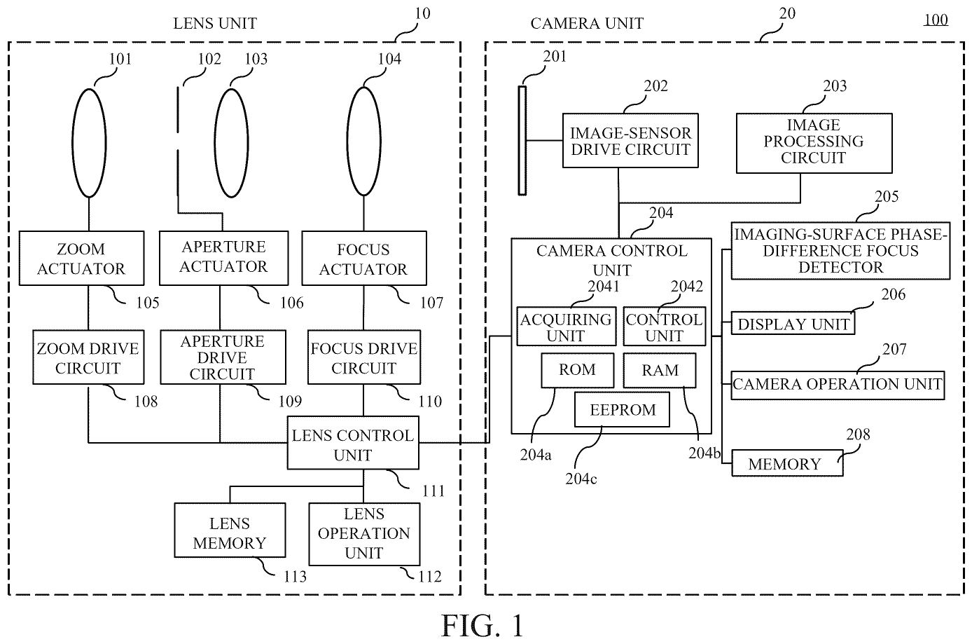

Referring now to FIG. 1, a description will be given of an example of the functional configuration of a digital camera 100 as an example of an image pickup apparatus according to this embodiment. FIG. 1 is a block diagram of the digital camera (image pickup apparatus) 100. The digital camera 100 according to this embodiment is a lens interchangeable type camera, and includes a lens unit 10 having an optical system (imaging optical system), and a camera unit 20. In this embodiment, the lens unit 10 may be attachable to and detachable from the camera unit 20, or integrated with the camera unit 20. In a case where the lens unit 10 is attachable to and detachable from the camera unit 20, the lens unit 10 constitutes a lens apparatus (interchangeable lens), and the camera unit 20 constitutes a camera body (image pickup apparatus), and the lens apparatus and camera body form an imaging system.

The lens unit 10 includes an optical system (including a first lens unit 101, an aperture stop (diaphragm) 102, a second lens unit 103, a focus lens (focus lens unit) 104), and a drive/control system. Thus, the lens unit 10 is an imaging lens that includes the focus lens 104 and forms an optical image of an object.

The first lens unit 101 is located at the tip of the lens unit 10 and is held so that it can move in the optical axis direction. The aperture stop 102 has the function of adjusting the light amount during imaging (capturing an image or photography). The aperture stop 102 and second lens unit 103 can move together in the optical axis direction, and by moving in conjunction with the first lens unit 101, a zoom function is achieved. The focus lens 104 can also move in the optical axis direction, and the object distance (in-focus distance) at which the lens unit 10 is in focus changes according to its position. Controlling the position of the focus lens 104 in the optical axis direction can provide focusing that adjusts the in-focus distance of the lens unit 10.

The drive/control system has a zoom actuator 105, an aperture actuator 106, and a focus actuator 107. The drive/control system further includes a zoom drive circuit 108, an aperture drive circuit 109, a focus drive circuit 110, a lens control unit 111, a lens operation unit 112, and a lens memory 113. The zoom drive circuit 108 drives the first lens unit 101 and the second lens unit 103 in the optical axis direction using the zoom actuator 105, and controls the angle of view of the optical system in the lens unit 10. The aperture drive circuit 109 drives the aperture stop 102 using the aperture actuator 106, and controls the aperture diameter and opening/closing operation of the aperture stop 102. The focus drive circuit 110 drives the focus lens 104 in the optical axis direction using the focus actuator 107, and controls the in-focus distance of the optical system of the lens unit 10. The focus drive circuit 110 detects the current position of the focus lens 104 using the focus actuator 107.

The lens control unit 111 controls the zoom drive circuit 108, the aperture drive circuit 109, and the focus drive circuit 110. The lens control unit 111 communicates with the camera control unit 204. For example, the lens control unit 111 detects the position of the focus lens 104 and notifies the camera control unit 204 of the focus lens position information. The lens control unit 111 also controls the zoom drive circuit 108, aperture drive circuit 109, and focus drive circuit 110 in accordance with processing commands from the camera control unit 204. The lens control unit 111 also controls the zoom drive circuit 108 and focus drive circuit 110 based on information notified by operation of the lens operation unit 112, which will be described later.

The lens operation unit 112 includes a zoom ring, focus ring, etc. It accepts ring operations by the user and notifies the lens control unit 111 of the operation information. This achieves zoom operations by the user and MF operations using the focus ring.

The lens memory 113 previously stores optical information necessary for the AF detection. The camera control unit 204 controls the operation of the lens unit 10, for example, by executing programs stored in the built-in nonvolatile memory or the lens memory 113.

The camera unit 20 includes an imaging system (image sensor 201), and a drive/control system. The imaging unit includes the first lens unit 101, aperture stop 102, second lens unit 103, and focus lens in the lens unit 10 and the image sensor 201 in the camera unit 20.

The image sensor 201 includes a CMOS image sensor and peripheral circuits, and includes m pixels horizontally and n pixels vertically (where m and n are integers of 2 or greater). The image sensor 201 according to this embodiment has a pupil division function and can provide phase-difference AF using image data. An image-sensor drive circuit 202 controls the operation of the image sensor 201, and A/D converts the acquired image signal and sends it to the camera control unit 204.

The image processing circuit 203 generates data for phase-difference AF and image data for display and recording from the image data (imaging signal) output by the image sensor 201. The image data acquired by the sensor 201 is subjected to typical image processing performed in digital cameras, such as gamma conversion, white balance adjustment, color interpolation, and compression encoding.

The camera control unit 204 performs all calculations and controls related to the camera unit 20, and controls the image-sensor drive circuit 202, image processing circuit 203, imaging-surface phase-difference focus detector 205, display unit 206, camera operation unit 207, and memory 208. The camera control unit 204 is connected to the lens control unit 111 via signal lines between the lens unit 10 and camera unit 20, and communicates commands and data with the lens control unit 111. The camera control unit 204 sends to the lens control unit 111 requests for the focus lens position, requests to drive the aperture stop, zoom lens, and focus lens at a predetermined drive amount, and requests to acquire optical information unique to unit 10.

The camera control unit 204 includes a built-in Read Only Memory (ROM) 204a, Random Access Memory (RAM) 204b, and Electrically Erasable Programmable Read-Only Memory (EEPROM) 204c. The ROM 204a stores programs that control camera operation. The RAM 204b stores variables. The EEPROM 204c stores a variety of parameters and various setting information for the camera unit 20 set by the user.

The camera control unit 204 includes an acquiring unit 2041 and a control unit 2042. The acquiring unit 2041 acquires movement information on an object (or object movement information). The control unit 2042 controls the focus lens using focus information acquired from the imaging signal. The control unit 2042 also changes the processing regarding AF trackability according to the movement information on the object. The movement information includes information on whether the object has moved. For example, in a case where the object has moved, the control unit 2042 changes the processing regarding trackability so that trackability is higher than that in a case where the object has not moved. A moving direction of the object viewed from an image pickup apparatus is, for example, a close-distance direction or an infinity direction. The acquiring unit 2041 acquires object movement information, for example, in a case where the first operation unit for MF (the focus ring of the lens operation unit 112) is operated.

The imaging-surface phase-difference focus detector 205 performs focus detection using a phase-difference detecting method and focus detecting data (focus information acquired from the imaging signal) obtained by the image processing circuit 203. More specifically, the image processing circuit 203 generates as focus detecting data paired image data formed by light beams passing through two pairs of pupil regions. The imaging-surface phase-difference focus detector 205 then detects a focus shift amount based on a shift amount between the paired image data. Thus, the imaging-surface phase-difference focus detector 205 according to this embodiment does not use a dedicated AF sensor, but performs phase-difference AF (imaging-surface phase-difference AF) based on the output of sensor 201. The operation of the imaging-surface phase-difference focus detector 205 will be described in detail later.

The display unit 206 includes a liquid crystal display (LCD) and other components, and displays information about an imaging mode of the camera, a preview image before imaging and a confirmation image after imaging, and a focus status display image during focus detection. The display unit 206 includes a touch operation function, so the camera can be operated by directly touching the display unit 206.

The camera operation unit 207 includes a power switch, a focusing start switch, a release (imaging trigger) switch, a zoom operation switch, an imaging mode switch, a moving image capturing switch, etc. The memory (storage unit) 208 is a removable flash memory that stores captured images.

### Details of Imaging-Surface Phase-Difference Focus Detector 205

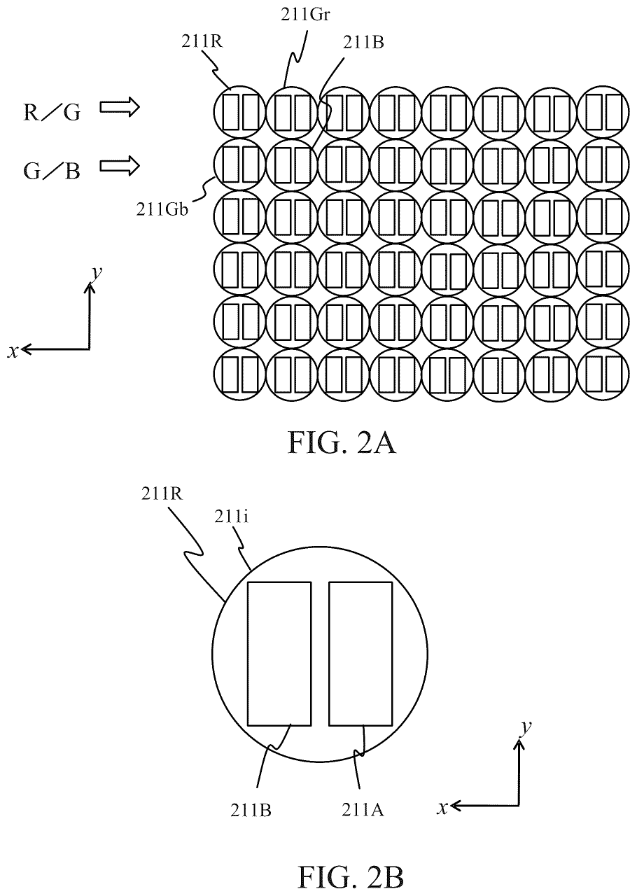

Next, the operation of the imaging-surface phase-difference focus detector 205 will be described in detail with reference to FIGS. 2A and 2B. FIG. 2A is a pixel array diagram of the image sensor 201 in this embodiment, illustrating the six vertical rows (Y direction) and eight horizontal columns (X direction) of a two-dimensional C-MOS area sensor when viewed from the lens unit 10 side. The image sensor 201 has Bayer-array color filters, with red (R) and green (G) color filters arranged alternately from left to right in odd-numbered rows of pixels, and green (G) and blue (B) color filters arranged alternately from left to right in even-numbered rows of pixels.

With reference to FIG. 2B, a pixel 211R will be described. A circle 211i represents an on-chip microlens, and a plurality of rectangles 211A and 211B arranged inside the on-chip microlens are photoelectric converters. Pixels 211Gr, 211Gb, and 211B have a similar configuration.

In this embodiment, the image sensor 201 has pixels (211R, 211Gr, 211Gb, 211B) in which the photoelectric converter of the imaging pixel is divided into two in the X direction. The photoelectric conversion signals from each photoelectric converter can be used as data for the phase-difference AF, or can be used to generate parallax images that constitute a three-dimensional image. The sum of the photoelectric conversion signals can also be used as normal captured image data.

A description will now be given of the pixel signals in a case where the phase-difference AF is performed. In this embodiment, the microlens 211i in FIG. 2B and the divided photoelectric converters 211A and 211B pupil-divide light from the imaging optical system. The photoelectric converters 211A and 211B in FIG. 2B are used as a pair. This enables focus detection based on an image shift amount (phase difference) in the X direction.

A description will now be given of phase-difference AF using focus detection based on the image shift amount in the X direction. In FIG. 2B, signals from the photoelectric converters 211A arranged in the plurality of pixels 211R within a predetermined range arranged in the same pixel row will be referred to as AF image A. The signals from the photoelectric converters 211B will be referred to as AF image B. The outputs of the photoelectric converters 211A and 211B use pseudo-luminance (Y) signals calculated by adding the outputs of green, red, blue, and green included in the unit array of color filters, but AF images A and B may be organized for each color, red, blue, and green. The relative image shift amount between the pair of image signals, the AF images A and B generated in this way, is detected by correlation calculation, and thereby a prediction can be made as the degree of correlation between the pair of image signals. The camera control unit 204 can detect the defocus amount of a predetermined region by multiplying the prediction by a conversion coefficient. The sum of the outputs of the photoelectric converters 211A and 211B forms one pixel (output pixel) of the output image.

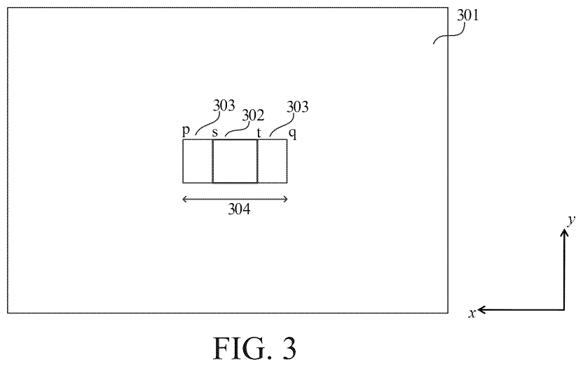

Referring now to FIG. 3, a detailed description will be given of focus detection processing. FIG. 3 explains focus detection processing. FIG. 3 illustrates an example of an AF area 302 on the pixel array 301 of the image sensor 201 in the focus detection processing.

Shift areas 303 on both sides of the AF area 302 are areas for correlation calculations. Therefore, an area 304, which is the combination of the AF area 302 and shift areas 303, is a pixel area required for correlation calculations. In FIG. 3, p, q, s, and t each represent coordinates in the X direction, with p and q representing the X coordinates of the start and end points of pixel area 304, and s and t representing the X coordinates of the start and end points of the AF area 302.

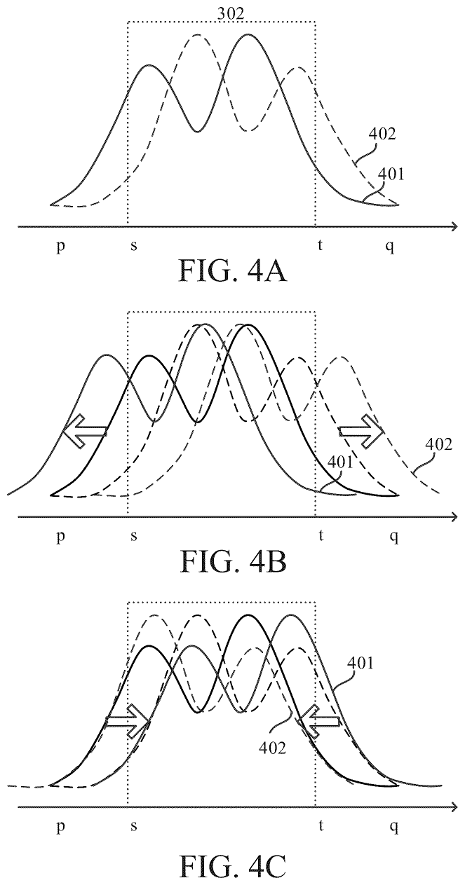

FIGS. 4A, 4B, and 4C illustrate an example of a pair of AF image signals acquired from a plurality of pixels included in the AF area 302 illustrated in FIG. 3. A solid line 401 represents the AF image A, and a broken line 402 represents the AF image B. FIG. 4A illustrates the AF images A and B before shifting, while FIGS. 4B and 4C illustrate the AF images A and B after they have been shifted in the positive and negative directions from the state illustrated in FIG. 4A. In calculating the correlation between the pair of AF images A 401 and B 402, both AF images A 401 and B 402 are shifted by one bit in arrow directions.

A description will now be given of a calculation method of a correlation amount. First, as illustrated in FIGS. 4B and 4C, the AF images A 401 and B 402 are each shifted by one bit, and the sum of the absolute values of the differences between the AF images A 401 and B 402 is calculated. Where a shift amount is i, the maximum shift amount in the negative direction is p−s, the maximum shift amount in the positive direction is q−t, x is the start coordinate of the AF area 302, and y is the end coordinate of the AF area 302, a correlation amount COR can be calculated using the following equation (1):

$$COR [ i ] = {\sum }_{k = x}^{y} \vert A [ k + i ] - B [ K - i ] \vert \qquad ( 1 )$$

$$\{ ( p - s ) < i < ( q - t ) \}$$

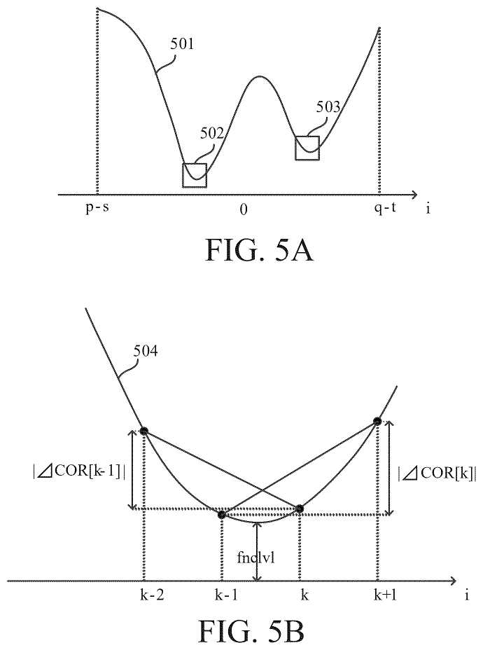

FIG. 5A illustrates an example of a relationship between the shift amount and the correlation amount COR. In FIG. 5A, the horizontal axis represents the shift amount, and the vertical axis represents the correlation amount COR. Among extreme values 502 and 503 in the correlation amount 501 that changes with the shift amount, the coincidence degree between the pair of AF images A and B becomes highest with a shift amount corresponding to a smaller correlation amount.

A description will now be given of a calculation method for a correlation change amount. A difference in the correlation amount between every other shift in the waveform of the correlation amount 501 illustrated in FIG. 5A is calculated as the correlation change amount. Where the shift amount is i, the maximum shift amount in the negative direction is p−s, and the maximum shift amount in the positive direction is q−t, the correlation change amount ΔCOR can be calculated using the following equation (2):

$$Δ COR [ i ] = COR [ i - 1 ] - COR [ i + 1 ] \qquad ( 2 )$$

$$\{ ( p - s + 1 ) < i < ( q - t - 1 ) \}$$

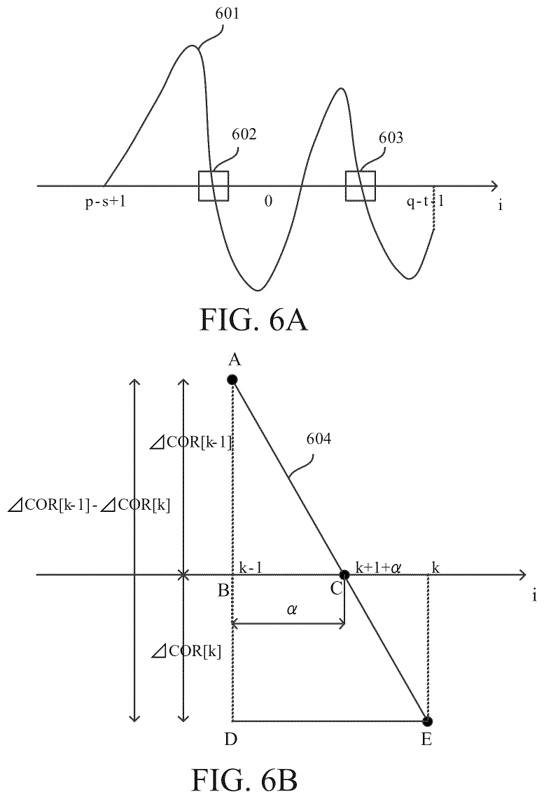

FIG. 6A illustrates an example of a relationship between the shift amount and the correlation change amount ΔCOR. The horizontal axis represents the shift amount, and the vertical axis represents the correlation change amount ΔCOR. The correlation change amount 601, which changes with the shift amount, goes from positive to negative at portions 602 and 603. The state where the correlation change amount is 0 is called a zero crossing, and the coincidence degree between the pair of AF images A and B is highest. Therefore, the shift amount that produces the zero crossing is the image shift amount.

FIG. 6B illustrates an enlarged view of the portion 602 in FIG. 6A. Reference numeral 604 denotes a portion of the correlation change amount 601. A calculation method of an image shift amount will be described with reference to FIG. 6B.

A shift amount (k−1+α) that produces the zero crossing is divided into an integer part β (=k−1) and a decimal part α. The decimal portion α can be calculated using equation (3) below, based on the similarity between triangles ABC and ADE in FIG. 6B:

$$AB : AD = BC : DE \qquad ( 3 )$$

$$Δ COR [ K - 1 ] = Δ COR [ k - 1 ] - Δ COR [ k ] = α : k - ( k - 1 )$$

$$α = \frac{Δ COR [ k - 1 ]}{Δ COR [ k - 1 ] - Δ COR [ k ]}$$

The integer portion β can be calculated using equation (4) below based on FIG. 6B:

$$β = k - 1 \qquad ( 4 )$$

The sum of α and β can then be used to determine the image shift amount, i.e., the prediction as the correlation degree between the pair of image signals.

As illustrated in FIG. 6A, if there are multiple zero crossings in the correlation change amount ΔCOR, the one with the steepest change in the correlation change amount ΔCOR nearby is determined to be the first zero crossing. This steepness is an index of the ease of AF, with a larger value indicating more accurate AF. The steepness maxder can be calculated using the following equation (5):

$$max der = \vert Δ COR [ k - 1 ] \vert + \vert Δ COR [ k ] \vert \qquad ( 5 )$$

Thus, in this embodiment, in a case where there are a plurality of zero crossings in the correlation change amount, the first zero crossing is determined based on the steepness of the correlation change amount, and the shift amount that gives the first zero crossing is used as the prediction.

A description will now be given of a calculation method for the reliability of the image shift amount. The reliability of the image shift amount can be defined by the coincidence degree between the pair of AF images A and B (referred to as the two-image coincidence degree hereinafter) fnclvl and the steepness of the correlation change amount described above. The two-image coincidence degree is an index that indicates the accuracy of the image shift amount, and in the correlation calculation method used in this embodiment, a smaller value indicates better accuracy.

FIG. 5B is an enlarged view of the portion 502 in FIG. 5A, and reference numeral 504 denotes a portion of the correlation amount 501. The two-image coincidence degree fnclvl can be calculated using the following equation (6):

$$fnclvl = COR [ k - 1 ] + Δ COR [ k - 1 ] / 4 \qquad ( 6 )$$

$$if \vert ΔCOR [ k - 1 ] \vert \times 2 \leq maxder$$

$$fnclvl = COR [ k ] + Δ COR [ k ] / 4$$

$$if \vert ΔCOR [ k - 1 ] \vert \times 2 > maxder$$

### Details of Various Processing Performed by Camera Unit 20

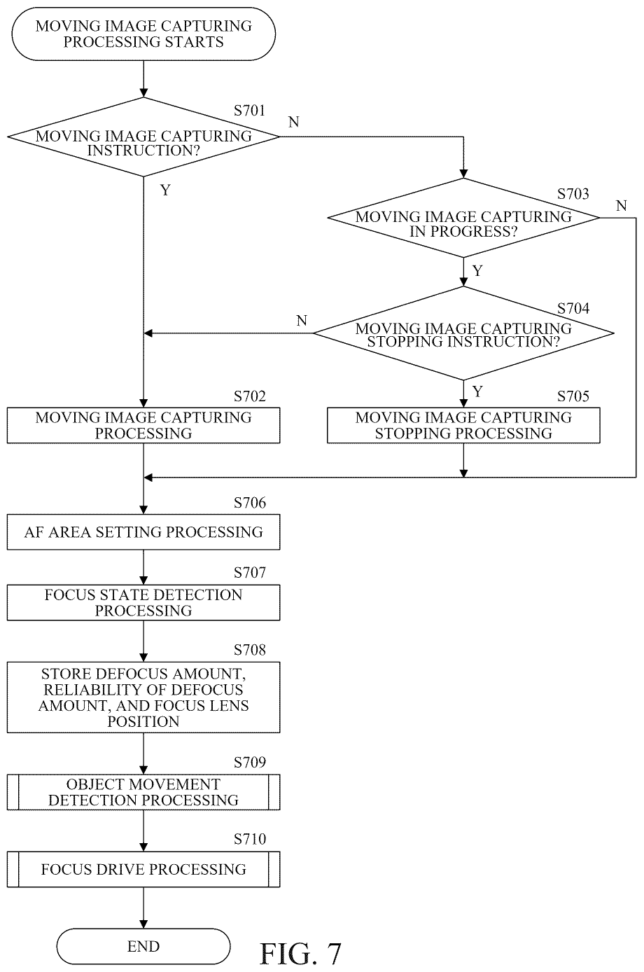

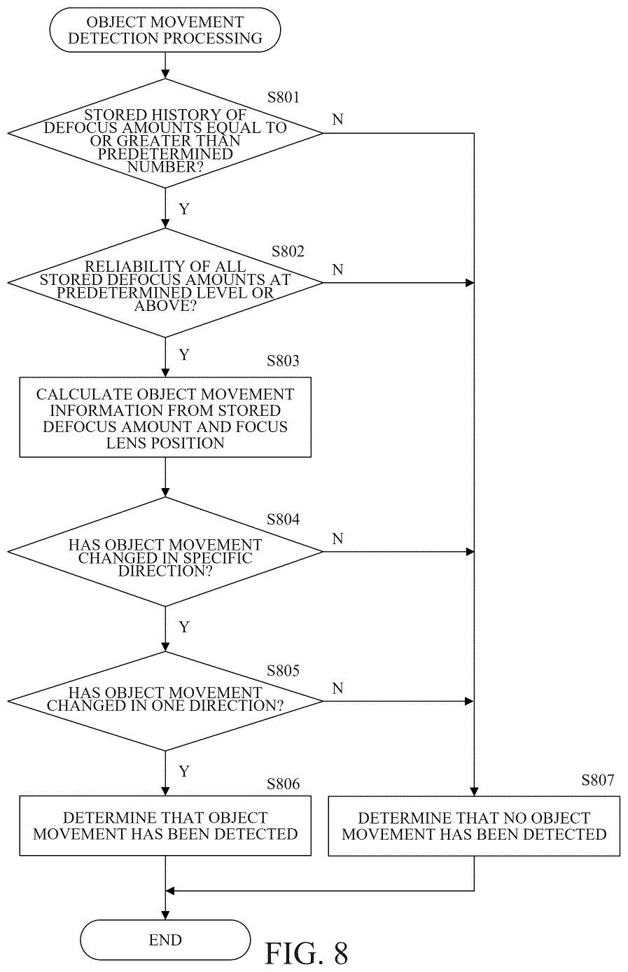

The camera control unit 204 in the camera unit 20 performs the following processing according to an imaging processing program, which is a computer program. FIG. 7 is a flowchart illustrating the procedure of the moving image capturing processing. The camera control unit 204 repeatedly performs the moving image capturing processing to perform various moving image capture control and AF controls. This embodiment will discuss only moving image capturing processing, but the camera unit 20 may also be able to execute still image capturing processing.

First, in step S701, the camera control unit 204 determines whether an instruction to start moving image capturing (moving image capturing instruction) has been input by touching the camera operation unit 207 or the display unit 206. The moving image capturing instruction is notified in a case where the moving image capturing switch on the camera operation unit 207 is pressed or the moving image capturing icon on the display unit 206 is pressed while moving image capturing is not in progress. In a case where the moving image capturing instruction has been notified, the flow proceeds to step S702, and in a case where the moving image capturing instruction has not been notified, the flow proceeds to step S703.

In step S702, the camera control unit 204 performs moving image capturing processing to record a moving image in the memory 208, and the flow proceeds to step S706.

In step S703, the camera control unit 204 determines whether the moving image capturing has already been in progress. In a case where moving image capturing has been in progress, the flow proceeds to step S704, and in a case where moving image capturing is not in progress, the flow proceeds to step S706.

In step S704, the camera control unit 204 determines whether a moving image capturing stopping instruction has been input by touching the camera operation unit 207 or the display unit 206. The moving image capturing stopping instruction is notified when the moving image capturing switch on the camera operation unit 207 is pressed or the moving image capturing icon on the display unit 206 is pressed during moving image capturing. In a case where the moving image capturing stopping instruction has been notified, the flow proceeds to step S705; in a case where the moving image capturing stopping instruction has not been notified, the flow proceeds to step S702 and continues moving image capturing processing.

In step S705, the camera control unit 204 performs moving image capturing stopping processing and stops recording the moving image in the memory 208, and the flow proceeds to step S706.

In step S706, the camera control unit 204 performs AF area setting processing, and the flow proceeds to step S707. The AF area setting processing sets the position of the object within the imaging screen to be subjected to AF. In this embodiment, even in performing the MF operation described below, the AF area is set in this step and used for the AF after the MF operation is completed.

In step S707, the camera control unit 204 causes the imaging-surface phase-difference focus detector 205 to perform focus state detection processing. Details of the focus detection processing have been described using FIGS. 3, 4A, 4B, 4C, 5A, 5B, 6A, and 6B. The camera control unit 204 performs processing to acquire information on a defocus amount for performing the imaging-surface phase-difference AF and the reliability of the defocus amount, and the flow proceeds to step S708.

In step S708, the camera control unit 204 stores the defocus amount, the reliability of the defocus amount, and the focus lens position, and the flow proceeds to step S709. This information is used in processing described below to detect object movement, predict object movement, and control the driving of the focus lens. The number and size of the history to be stored are determined based on the moving speed of the object targeted for focus tracking, the size of the installed ROM 204a, etc. In step S709, the camera control unit 204 performs object movement detection processing, and the flow proceeds to step S710. Details of the object movement detection processing will be described later.

In step S710, the camera control unit 204 performs focus drive processing, and the moving image capturing processing ends. Details of the focus drive processing will be described later.

Referring now to FIG. 8, a description will be given of the object movement detection processing performed by the camera control unit 204 in step S709 of FIG. 7.

In step S801, the camera control unit 204 determines whether the number of stored histories of defocus amounts is equal to or greater than a predetermined number. In a case where the number of stored histories is equal to or greater than the predetermined number, the flow proceeds to step S802. On the other hand, in a case where the number of stored histories is less than the predetermined number, the flow proceeds to step S807. This determination corresponds to the determination of whether the number of histories of information stored in the processing described in step S708 in the moving image capturing processing flowchart in FIG. 7 is equal to or greater than a predetermined number. The predetermined number used as the threshold value can be determined based on the movement detection accuracy of the object movement detection performed in subsequent processing, the size of the installed ROM 204a, and the like.

In step S802, the camera control unit 204 determines whether the reliability of all of the stored defocus amounts is at a predetermined level or above. In a case where all of the reliability is at a predetermined level or above, the flow proceeds to step S803. On the other hand, in a case where there is a history of reliability not at a predetermined level or above, the flow proceeds to step S807. The defocus amount reliability threshold value set in step S802 may be determined so that the calculated defocus amount and direction are reliable. In a case where the reliability of the defocus amount is low, the object movement may not be detected correctly, so this determination is made. The reliability of the defocus amount may be calculated using both the coincidence degree between the two images and the steepness of the image shift amount, or only one of them. Alternatively, it may be calculated using another indicator such as a signal level.

In step S803, the camera control unit 204 calculates object movement information from the stored defocus amount and the focus lens position, and the flow proceeds to step S804. Details will be described later.

In step S804, the camera control unit 204 determines whether or not there is a change in the object movement in a specific direction. In a case where there is a change in the object movement, the flow proceeds to step S805. On the other hand, in a case where there is no change in the object movement, the flow proceeds to step S807. Details of this processing will be described later.

In step S805, the camera control unit 204 determines whether or not the object movement changes have been in one direction of the close-distance direction and the infinity direction. In a case where the object movement changes have been one direction, the flow proceeds to step S806. On the other hand, in a case where the object movement changes have not been one direction, the flow proceeds to step S807. Details will be described later.

In step S806, the camera control unit 204 determines that object movement has been detected, and the object movement detection processing ends. On the other hand, in step S807, the camera control unit 204 determines that no object movement has been detected, and the object movement detection processing ends.

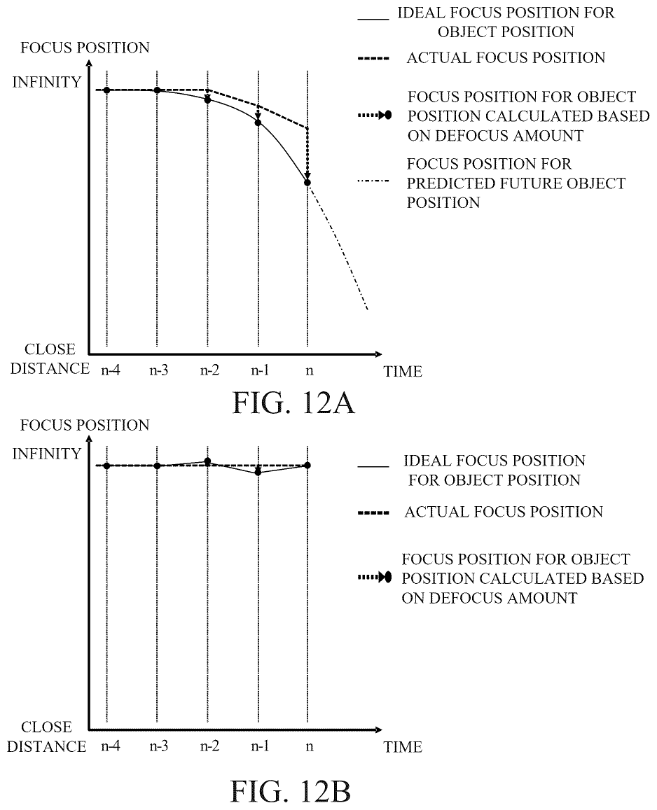

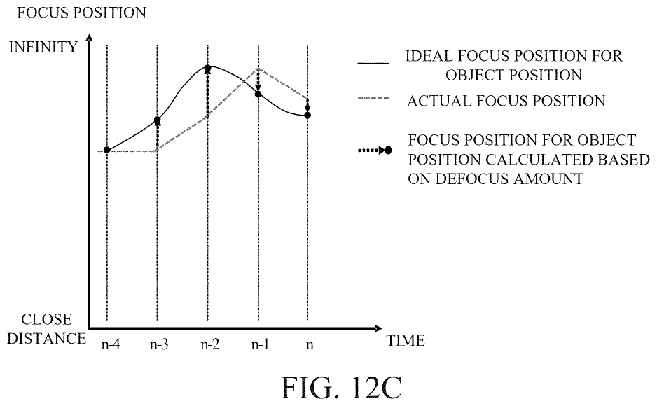

As described with reference to FIG. 8, the object movement detection processing determines in step S806 that object movement has been detected, or determines in step S807 that no object movement has been detected, according to the conditions. FIGS. 12A, 12B, and 12C illustrate an example of object movement detection. FIGS. 12A, 12B, and 12C are graphs with time on the horizontal axis and focus position on the vertical axis. These graphs illustrate an ideal focus position corresponding to the object position, and the position of the focus lens 104 acquired by the camera control unit 204 via the lens control unit 111. These graphs also illustrate the focus position for the object position calculated based on the defocus amount at five detected points from time n−4 to time n.

FIGS. 12A, 12B, and 12C each illustrate an example of different object movements. FIG. 12A is an example in a case where it is determined in step S806 that object movement has been detected, and also illustrates the focus position predicted for the future object position. FIGS. 12B and 12C are examples in a case where it is determined in step S807 that no object movement has been detected.

In FIG. 12A, as to the ideal focus position for the object position, it appears that the object is moving from the infinity side toward a close distance side, the object is moving unidirectionally (in one direction), and the object movement is to be detected. On the other hand, from the focus position information for the object position calculated in step S803 based on the actual focus position and defocus amount, object position change (or transition) information close to the transition of the ideal focus position for the object position is obtained. Based on this information, in step S804, it is determined whether the object movement has changed in a specific direction, and in FIG. 12A, it can be determined that the object movement has changed in the close-distance direction. To prevent erroneous determination that the object is moving even when it is not actually moving, a threshold value, for example, for determining that a change in focus position is greater than a predetermined value, or that the object has moved in the same direction a predetermined number of times or more.

In step S805, it is determined whether the object movement changes have been unidirectional. In FIG. 12A, it is unidirectional toward the close distance, so based on this determination result, it is determined in step S806 that the object movement has been detected. In a case where the object movement has been detected, the object position is predicted and focus driving is performed in the processing described later, so FIG. 12A illustrates the locus of the focus position for the predicted future object position as information for prediction.

In FIG. 12B, as to the ideal focus position for the object position, it changes little, and it appears that the object has hardly moved, so object movement is not to be detected. In such a case, due to step S804 that determines whether the object movement has changed in a specific direction, it is determined that there are no movement changes based on information such as little changes in focus position, as described above, and it is determined in step S807 that no object movement has been detected.

In FIG. 12C, as to the ideal focus position for the object position, it appears that the object has moved both toward infinity and toward a close distance, and it is difficult to predict future object movement. In this embodiment, in a case where it is difficult to predict object movement, i.e., in a case where the object movement changes are not unidirectional, control is performed to determine that no object movement has been detected. In FIG. 12C, although it can be determined in step S804 that the object movement changes have been in a specific direction, it is not determined in step S805 that the object movement changes are unidirectional, so it is determined in step S807 that no object movement has been detected.

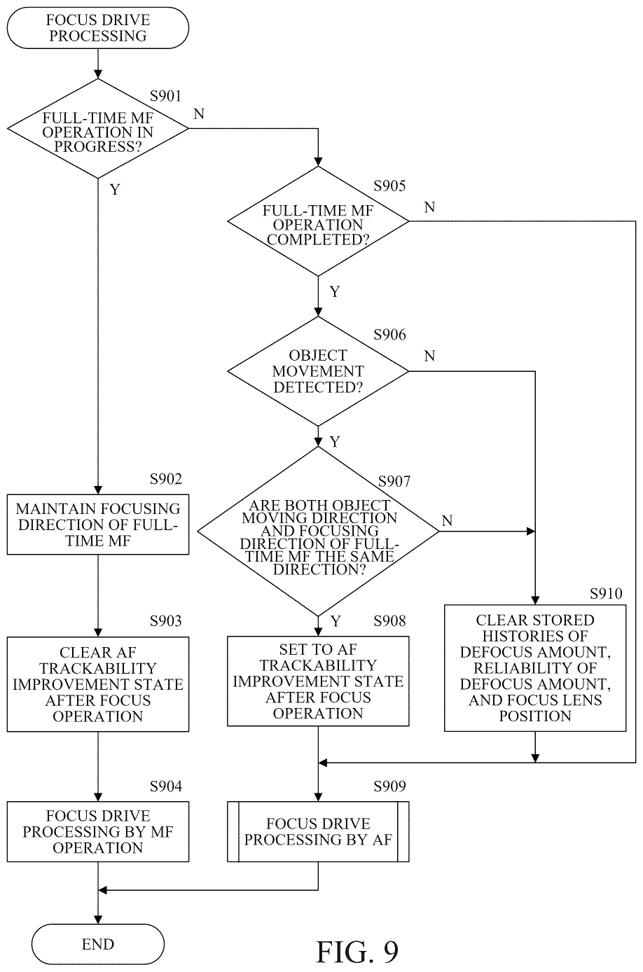

Next, with reference to FIG. 9, the focus drive processing performed by the camera control unit 204 in step S710 of FIG. 7 will be described. FIG. 9 is a flowchart illustrating the focus drive processing.

In step S901, the camera control unit 204 determines whether a full-time MF operation is in progress. In a case where the full-time MF operation is in progress, the flow proceeds to step S902. On the other hand, in a case where the full-time MF operation is not in progress, the flow proceeds to step S905.

In step S902, the camera control unit 204 maintains the focusing direction of the full-time MF, which is one of a close-distance direction and an infinity direction, and the flow proceeds to step S903.

In step S903, the camera control unit 204 clears the AF trackability improvement state after focus operation and the flow proceeds to step S904. The AF trackability improvement state after focus operation, which will be described in detail later, may be cleared as it is information that is not used during the full-time MF operation.

In step S904, the camera control unit 204 performs focus drive processing using the MF operation and the focus drive processing ends. The MF focus drive processing involves rotating the focus ring on the lens operation unit 112 toward infinity or a close distance, and performing focus drive according to the rotation amount. Instead of the focus ring operation, MF may also be performed according to button operation on the camera operation unit 207, for example.

In step S905, to which the flow proceeds in a case where it is determined in step S901 that full-time MF operation is not in progress, the camera control unit 204 determines whether the full-time MF operation has been completed. In a case where the full-time MF operation has been completed from the full-time MF state in step S901, the flow proceeds to step S906. In a case where the full-time MF operation has not originally been performed, or in a case where the processing described below, which is performed after the full-time MF operation is completed, has been performed, the flow proceeds to step S909.

In step S906, the camera control unit 204 determines whether the object movement has been detected. In a case where the object movement has been detected, i.e., in a case where the processing of step S806 in FIG. 8 has been performed, the flow proceeds to step S907. On the other hand, in a case where no object movement has been detected, i.e., in a case where the processing of step S807 in the flowchart of FIG. 8 has been performed, the flow proceeds to step S910.

In step S907, the camera control unit 204 determines whether both the object moving direction, which is the close-distance direction or the infinity direction when the object is viewed from the camera, and the focusing direction of the full-time MF are the same direction, i.e., the close-distance direction or the infinity direction. In a case where the object moving direction detected in step S806 in FIG. 8 and the focusing direction of the full-time MF stored in step S902 are the same direction (i.e., both directions are the close-distance direction or the infinity direction), the flow proceeds to step S908. On the other hand, in a case where the object moving direction and the focusing direction of the full-time MF are different directions, the flow proceeds to step S910.

In step S908, the camera control unit 204 sets to the AF trackability improvement state after focus operation, and the flow proceeds to step S909. In a case where the following conditions are met: a transition from the full-time MF operation state to a completion state is made in step S905; the object movement is detected in step S906; and the object moving direction and the focusing direction of the full-time MF are the same direction in step S907, the subsequent AF trackability is improved. This is because it can be determined that the user is highly likely to use the full-time MF operation to perform focus tracking on an object moving in the depth direction. In this case, focus tracking on the object may be maintained without delay even during AF after full-time MF. Details of the processing in the AF trackability improvement state will be described later.

In step S909, the camera control unit 204 performs focus drive by AF and the focus drive processing ends. Details of AF focus drive processing will be described later.

In step S910, to which the flow proceeds in a case where the object movement is not detected in step S906 or in a case where the object moving direction and the focusing direction of the full-time MF are different directions in step S907, the camera control unit 204 clears the stored histories of the defocus amount, reliability, and focus lens position. The flow then proceeds to step S909. In a case where no object movement has been detected, or in a case where the object movement direction and the focusing direction of the full-time MF are different directions, subsequent AF trackability will not be improved, even after full-time MF operation. In fact, by using information during the full-time MF operation for the subsequent AF processing, focusing behavior may be different from what the user expects. Thus, various information such as the defocus amount held during full-time MF is reset once.

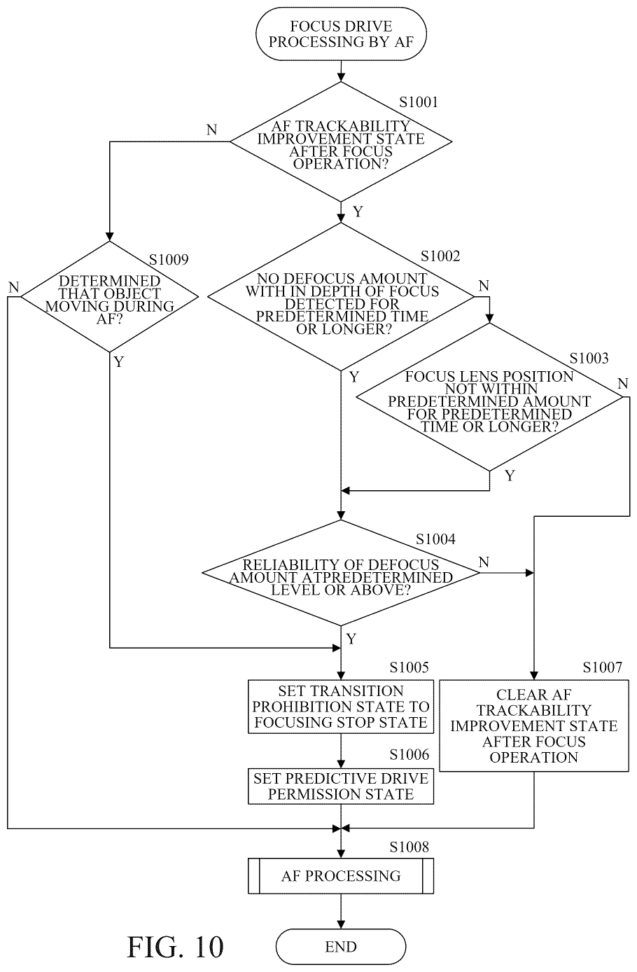

Next, with reference to FIG. 10, the AF focus drive processing performed by the camera control unit 204 in step S909 of FIG. 9 will be described. FIG. 10 is a flowchart illustrating the AF focus drive processing.

In step S1001, the camera control unit 204 determines whether AF trackability improvement state after the focus operation is set. In a case where the AF trackability improvement state after the focus operation is set, the flow proceeds to step S1002. On the other hand, in a case where the AF trackability improvement state after the focus operation is not set, the flow proceeds to step S1009. The improved AF tracking state after focus operation is the state set after the full-time MF operation in step S908 of FIG. 9 in a case where the detected object moving direction and the focusing direction of the full-time MF are the same direction.

In step S1002, the camera control unit 204 determines whether the defocus amount within the depth of focus has not been detected for a predetermined period of time or longer. In a case where the defocus amount within the depth of focus has not been detected for a predetermined period of time or longer, the flow proceeds to step S1004. On the other hand, in a case where the defocus amount within the depth of focus has been detected for a predetermined period of time or longer, the flow proceeds to step S1003.

In step S1003, the camera control unit 204 determines whether the focus lens position has not been within a predetermined amount for a predetermined period of time or longer. In a case where the focus lens position has not been within the predetermined amount for the predetermined period of time or longer, the flow proceeds to step S1004. On the other hand, in a case where the focus lens position has been within the predetermined amount for the predetermined period of time or longer, the flow proceeds to step S1007.

In step S1004, the camera control unit 204 determines whether the reliability of the defocus amount is at a predetermined level or above. In a case where the reliability of the defocus amount is at the predetermined level or above, the flow proceeds to step S1005. On the other hand, in a case where the reliability of the defocus amount is not at the predetermined level, the flow proceeds to step S1007.

The reliability threshold value of the defocus amount set in step S1004 may be set so that the calculated defocus amount and direction are reliable.

In step S1005, the camera control unit 204 sets a transition prohibition state to a focusing stop state, and the flow proceeds to step S1006.

In step S1006, the camera control unit 204 sets a predictive drive permission state, and the flow proceeds to step S1008.

In step S1007, the camera control unit 204 clears the AF tracking improvement state after focus operation, and the flow proceeds to step S1008.

In step S1008, the camera control unit 204 performs AF (execution) processing and AF focus drive processing ends. Details of the AF processing will be described later.

In a case where it is determined in step S1001 that the AF trackability improvement state after the focus operation is set, it determines whether to continue the state in steps S1002 to S1004. In a case where it is determined that the state is to be continued, step S1005 sets the transition prohibition state to the focusing stop state, and step S1006 sets the predictive drive permission state, and step S1008 performs the AF processing.

On the other hand, in a case where it is determined that the AF trackability improvement state after the focus operation is not to be continued, step S1007 clears the AF trackability improvement state after the focus operation, and step S1008 performs the AF processing. Regarding whether to continue the AF trackability improvement state after the focus operation, first in step S1002, in a case where the defocus amount within the depth of focus has not been detected for a predetermined time or longer, i.e., in a case where the object has not yet been fully focused, the policy is to continue the state. Even if the defocus amount within the depth of focus has been detected for the predetermined time or longer, if in step S1003 the focus lens position has not been within the predetermined amount for the predetermined time or longer, i.e., if the object is in focus but continues to move, the policy is to continue the state. However, if in step S1004 the reliability of the defocus amount is not at the predetermined level, i.e., if the object cannot be captured or it is assumed that the object has changed, tracking is difficult and thus the state is cleared in step S1007.

In step S1009, to which the flow proceeds in a case where it is determined in step S1001 that the AF trackability improvement state after the focus operation is not set, the camera control unit 204 determines whether it has determined that the object is moving during AF. In a case where it is determined that the object is moving, the flow proceeds to step S1005. On the other hand, in a case where it is not determined that the object is moving, the flow proceeds to step S1008. Even if step S1001 determines that the AF trackability improvement state after the focus operation is not set, if step S1009 determines that the object is moving during AF, steps S1005 and S1006 make a setting to improve the AF trackability. This determination may be processing similar to the object movement detection processing in FIG. 8, or separate processing that assumes that AF is in progress. At least, if the AF trackability improvement state after a focus operation is not set, various information such as the defocus amount is cleared in step S910 of FIG. 9, control is made so as not to improve the trackability just after a full-time MF operation, even if a determination is made in step S1009.

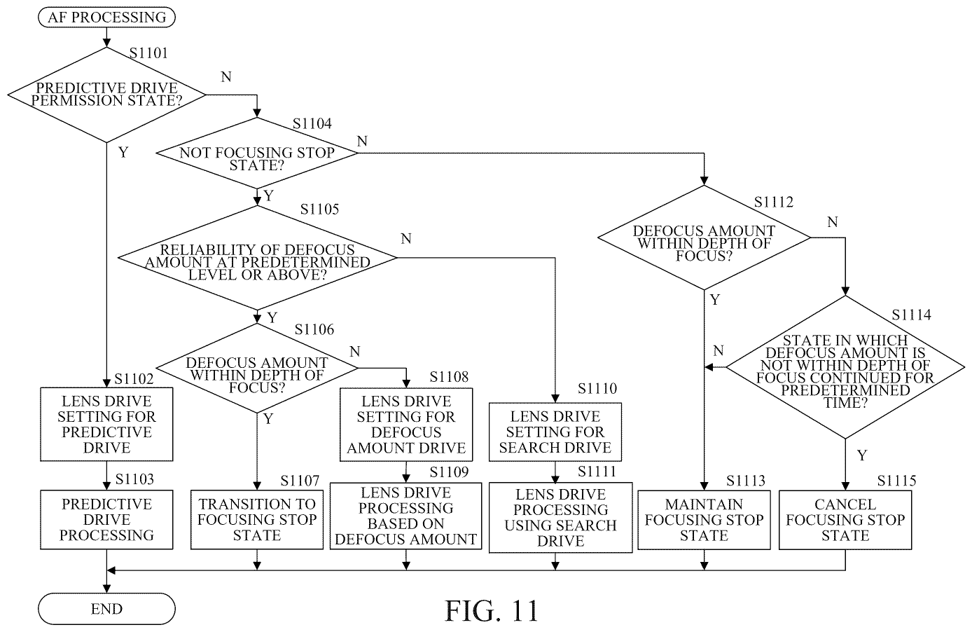

Next, with reference to FIG. 11, the AF processing performed by the camera control unit 204 in step S1008 of FIG. 10 will be described. FIG. 11 is a flowchart illustrating the AF processing.

In step S1101, the camera control unit 204 determines whether or not the predictive drive permission state is set. The predictive drive permission state is set in step S1006 of FIG. 10. In a case where the predictive drive permission state is not set, the flow proceeds to step S1102. On the other hand, in a case where the predictive drive permission state is not set, the flow proceeds to step S1104.

In step S1102, the camera control unit 204 performs lens drive settings for driving the focus lens 104 based on the histories of the past focus positions and defocus amounts to perform predictive drive, and the flow proceeds to step S1103.

In step S1103, the camera control unit 204 sends a drive command for the focus lens 104 to the lens control unit 111 based on the lens drive setting information set in step S1102, and the AF processing ends.

In step S1104, the camera control unit 204 determines whether the camera is in a focusing stop state due to AF. In a case where the camera is not in the focusing stop state, the flow proceeds to step S1105. On the other hand, in a case where the camera is in the focusing stop state, the flow proceeds to step S1112.

In step S1105, the camera control unit 204 determines whether the reliability of the defocus amount is at a predetermined level or above. In a case where the reliability of the defocus amount is at the predetermined level or above, the flow proceeds to step S1106. On the other hand, in a case where the reliability of the defocus amount is not at the predetermined level, the flow proceeds to step S1110. The reliability threshold value for the defocus amount set in step S1105 may be set to the maximum value of a reliability range in which not only the calculated defocus amount but also the defocus direction is unreliable. The reliability of the defocus amount may be calculated using both the two-image coincidence degree and the steepness of the image shift amount, or may be calculated using only one of them. Another index such as a signal level may also be used.

In step S1106, the camera control unit 204 determines whether the defocus amount is within the depth of focus. In a case where the defocus amount is within the depth of focus, the flow proceeds to step S1107. On the other hand, in a case where the defocus amount is not within the depth of focus, the flow proceeds to step S1108.

In step S1107, the camera control unit 204 considers that the defocus amount is within the depth of focus and transitions to a focusing stop state. Then, the AF processing ends.

In step S1108, the camera control unit 204 considers that the in-focus state has not yet been achieved, and performs a lens drive setting for driving the focus lens 104 based on the defocus amount. Then, the flow proceeds to step S1109.

In step S1109, the camera control unit 204 sends a drive command for the focus lens 104 to the lens control unit 111 based on the defocus amount and the lens drive setting information set in step S1108. Then, the AF processing ends.

In step S1110, since the reliability of the defocus amount is low, the camera control unit 204 cannot use the defocus amount to drive the focus lens 104. Thus, the camera control unit 204 performs a search drive to calculate the defocus amount while moving the focus lens 104 toward its movable end in order to detect a position of the focus lens 104 where a defocus amount with high reliability can be obtained. Hence, the camera control unit 204 first performs a lens drive setting for search drive. The lens drive setting for the search drive includes settings such as the drive speed and drive start direction of the focus lens 104. After this setting is performed, the flow proceeds to step S1111.

In step S1111, the camera control unit 204 sends a control command for the focus lens 104 to the lens control unit 111 based on the lens drive settings for search drive set in step S1110, and the AF processing ends.

In step S1112, the camera control unit 204 determines whether the defocus amount is within the depth of focus. In a case where the defocus amount is within the depth of focus, the flow proceeds to step S1113, and the focusing stop state is maintained. On the other hand, in a case where the defocus amount is not within the depth of focus, the flow proceeds to step S1114.

In step S1113, the camera control unit 204 maintains the focusing stop state and the AF processing ends.

In step S1114, the camera control unit 204 determines whether the state in which the defocus amount is not within the depth of focus has continued for a predetermined time. In a case where this condition is met, the flow proceeds to step S1115. On the other hand, in a case where this condition is not met, the flow proceeds to step S1113.

In step S1115, in a case where the defocus amount has been outside the depth of focus for a predetermined time, the camera control unit 204 cancels the focusing stop state and terminates the AF processing in order to track the focus change.

In this embodiment, in a case where the AF trackability improvement state after the focus operation state is set in step S908 of FIG. 9 and the predictive drive permission state is set in step S1006 by the processing of FIG. 10, predictive drive processing is performed in the processing of steps S1101 to S1103. Thereby, predictive drive processing is immediately performed even in a case where AF follows the full-time MF operation, and thus object trackability can be improved. In the predictive drive processing, the transition to the focusing stop state in step S1107 is not performed, and thus trackability on the object can be improved.

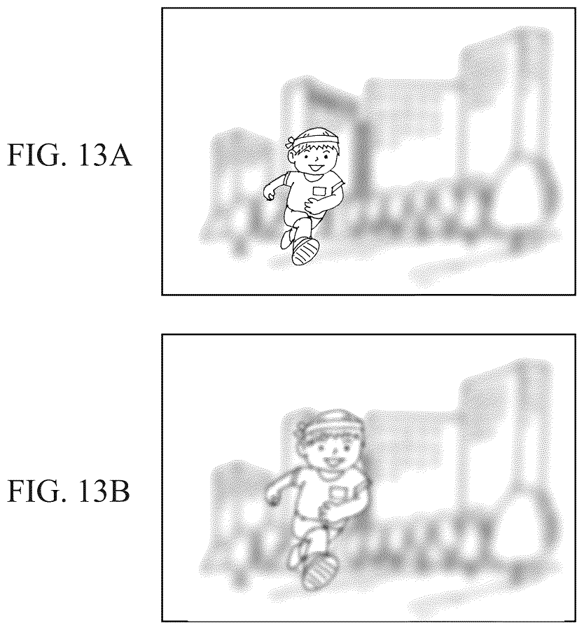

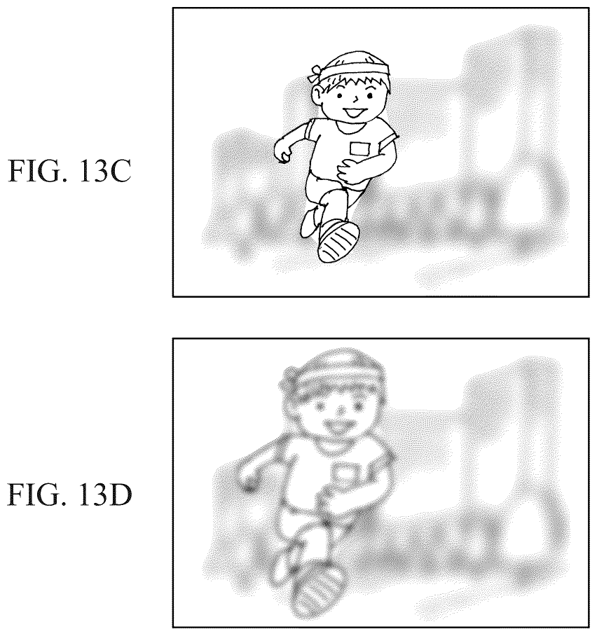

FIGS. 13A, 13B, 13C, and 13D explain the problems that arise when this embodiment is not applied. FIGS. 13A, 13B, 13C, and 13D illustrate scenes in which a person is approaching. FIGS. 13A, 13B, 13C, and 13D also illustrate the chronological changes in the same scene, with time passing in the order of FIGS. 13A, 13B, 13C, and 13D. FIGS. 13A, 13B, 13C, and 13D also illustrate the focus state of the person.

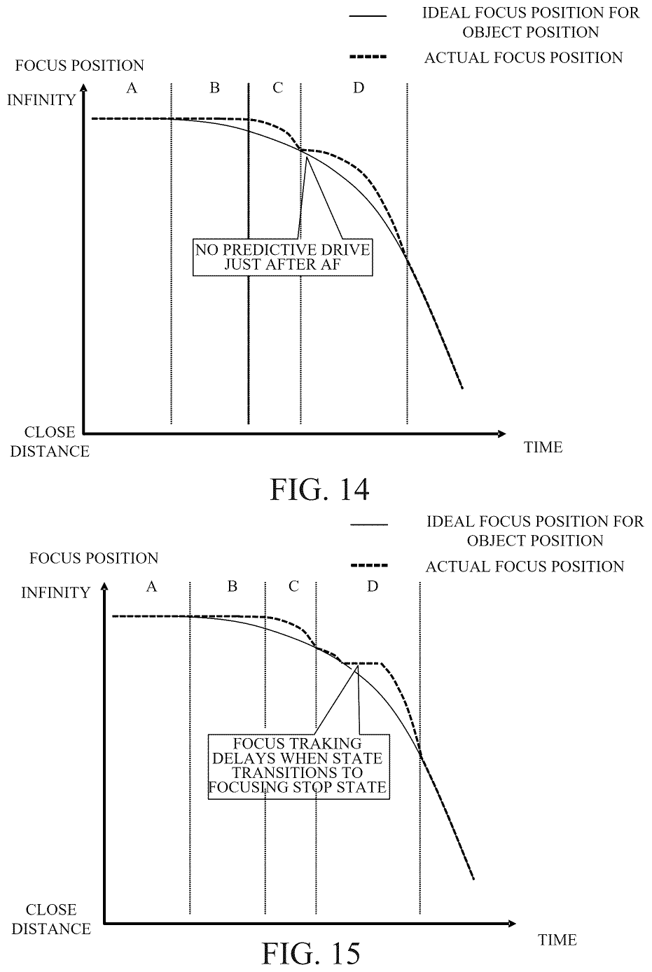

FIG. 14 illustrates the ideal focus position and actual focus position for the object position in each of the scenes in FIGS. 13A, 13B, 13C, and 13D. FIGS. 13A, 13B, 13C, and 13D correspond to time ranges A, B, C, and D in FIG. 14, respectively. FIG. 14 will also be explained when describing FIGS. 13A, 13B, 13C, and 13D.

FIG. 13A illustrates a state in which a person is stationary and has not yet started moving. The person is in focus, and in the range A in FIG. 14, the ideal focus position and actual focus position for the object position are the same, indicating an in-focus state. This corresponds to the focusing stop state of step S1107 in FIG. 11.

FIG. 13B illustrates a state in which the person suddenly starts moving toward the close distance from the state in FIG. 13A. In the range B in FIG. 14, since the person suddenly starts moving toward the close distance, the ideal focus position for the object position changes toward the close distance. On the other hand, in moving image capturing, particularly as described in FIG. 7, the behavior of the focus lens during focusing is recorded as part of a moving image. Therefore, control is performed to prevent undesirable focus lens behavior, such as an immediate focus shift when an object not to be captured passes in front of the person. From the focusing stop state is set in step S1107 of FIG. 11, the focusing stop state is canceled in step S1105 in a case where a state in which a defocus amount outside a depth of focus continues for a predetermined period of time due to the determinations in steps S1112 and S1114. After the focusing stop state is canceled, the AF drives the focus lens for focusing in the processing of steps S1103, S1109, and S1111.

FIG. 13B illustrates a state in which focus cannot follow an object distance change caused by the person suddenly moving toward the close distance side because the focusing stop state continues. Therefore, in the range B of FIG. 14, the actual focus position does not change, and a difference occurs between the object position and the ideal focus position, and the object is out of focus.

FIG. 13C illustrates a state in which the user has used a full-time MF operation to recover from the focus tracking delay and focused on a person who continues to move toward the close distance, from the state in FIG. 13B. As discussed above, it is possible to expect focus tracking on the person by waiting for the AF processing in FIG. 11 to change from a focusing stop state to a focus lens driving state. However, one of the methods for the user to perform focus tracking at an earlier point in time is to use a full-time MF operation to perform focus tracking. This is the state after step S904 of the focus drive processing in FIG. 9 has been executed.

In the range C in FIG. 14, the person continues to move toward the close distance, so the ideal focus position for the object position continues to change toward the close distance, but the full-time MF operation has caused the actual focus position to catch up with the ideal focus position for the object position.

FIG. 13D illustrates the state in which the user has stopped the full-time MF operation and changed to AF on the person who continues to move toward the close distance, from the state in FIG. 13C.

In the range D of FIG. 14, since the person continues to move toward the close distance, the ideal focus position for the object position continues to change toward the close distance, but a difference from the actual focus position occurs, and defocus blur occurs. This defocus blur is as illustrated in FIG. 13D.

In a case where this embodiment is not applied, focus tracking delay may occur. This is a state in which the AF trackability improvement state after the focus operation of step S1001 in FIG. 10 is not set, and the system always operates in a state equivalent to not meeting the conditions. In such a state, when the full-time MF operation is switched to AF, the AF detecting information during the full-time MF operation, i.e., information on whether the person is moving toward the close distance, cannot be utilized, and predictive drive processing such as step S1103 in FIG. 11 cannot be performed. In particular, in a case where a drive amount of the focus lens 104 for focus tracking is large, for example, for a high moving speed of the person, focus tracking may lag behind the person, as in FIG. 13D and the range D in FIG. 14, and the person may be blurred.

The description with reference to FIGS. 13A, 13B, 13C, and 13D uses an object distance change of a person as an example, but the type of object is not limited to a person and can be any object in which the object distance changes. For example, it could be a scene in which an animal is approaching or a scene in which an object grasped by a hand is introduced. It could also be a case in which the object is moving away rather than approaching.

FIG. 15 illustrates another example of the ideal focus position and actual focus position for the object position in each of the scenes in FIGS. 13A, 13B, 13C, and 13D. As in FIG. 14, ranges A, B, C, and D in FIG. 15 correspond to FIGS. 13A, 13B, 13C, and 13D, respectively. Ranges A, B, C, and D in FIG. 15 are the same as ranges A, B, C, and D in FIG. 14, and thus a description thereof will be omitted.

The range D in FIG. 15 illustrates a case where, after the user stops the full-time MF operation and changes it to AF, the actual focus position catches up with the ideal focus position for the object position, i.e., focus tracking is successful when AF starts. The focus trackability by AF varies according to the performance of the focus actuator 107 of the lens unit 10 attached to the camera unit 20, and the focus speed information set in the lens drive setting for defocus amount drive set in step S1108 in FIG. 11. Thus, in some cases, as in the range D in FIG. 15, focus tracking on the object may be possible when AF starts.

The range D in FIG. 15 illustrates a case where, in step S1106 in FIG. 11, it is determined that the defocus amount is within the depth of focus, and the system transitions to a focusing stop state in step S1107. In a case where the focusing stop state is set in step S1107, focus lens drive is temporarily suspended until it is determined in step S1112 that the defocus amount is not within the depth of field, and in step S1114 that this state has continued for a predetermined time.

This can improve focus stability during moving image capturing in scenes where the object to be captured is not moving much. On the other hand, in scenes where a person is constantly moving toward a close distance, as in this case, focus delays may occur. As illustrated in FIGS. 13A, 13B, 13C, 13D, 14, and 15, in a state where this embodiment is not applied, focus tracking delay may occur in AF after the full-time MF operation in capturing an object moving in the depth direction.

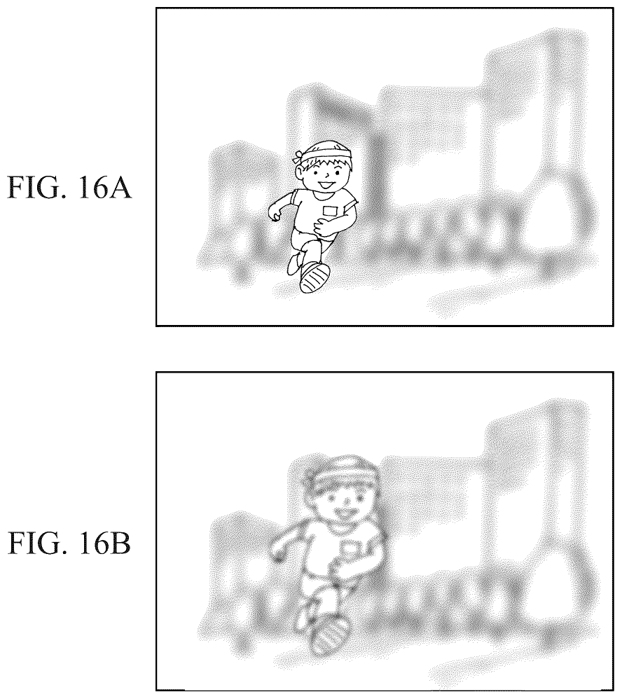

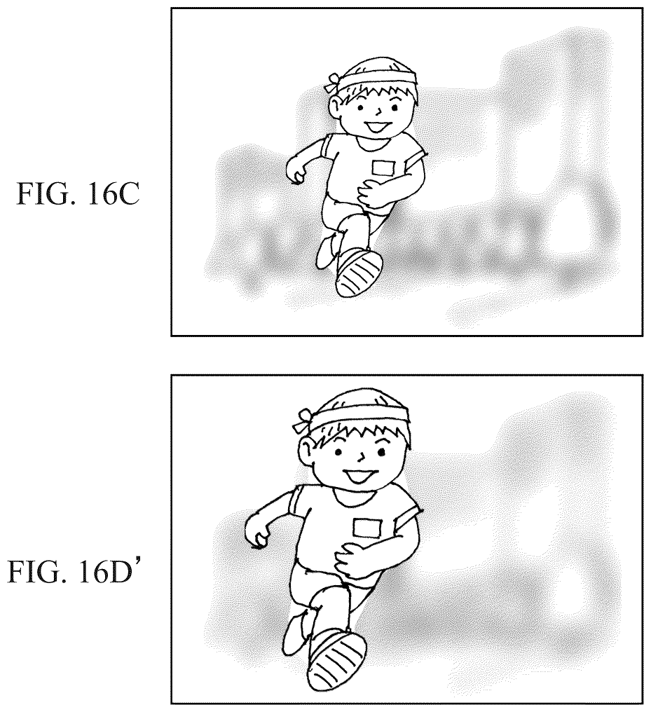

FIGS. 16A, 16B, 16C, and 16D′ illustrate an example of the effect of applying this embodiment. Similarly to FIGS. 13A, 13B, 13C, and 13D, FIGS. 16A, 16B, 16C, and 16D′ illustrate a scene in which a person is approaching. FIGS. 16A, 16B, 16C, and 16D′ illustrate the chronological changes in the same scene, with time passing in the order of FIGS. 16A, 16B, 16C, and 16D′. FIGS. 16A, 16B, 16C, and 16D′ also illustrate the focus state of the person. FIGS. 16A, 16B, and 16C are similar to FIGS. 13A, 13B, and 13C, so a description thereof will be omitted.

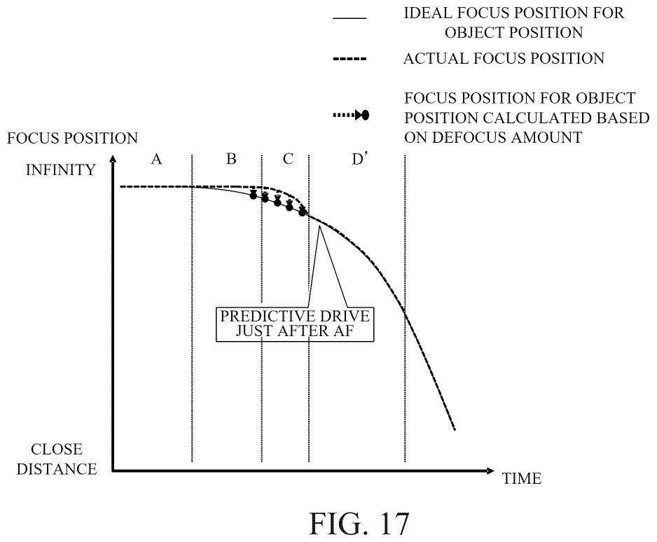

FIG. 17 illustrates the ideal focus position and actual focus position for the object position in each of the scenes in FIGS. 16A, 16B, 16C, and 16D′. FIGS. 16A, 16B, 16C, and 16D′ correspond to time ranges A, B, C, and D′ in FIG. 17, respectively. The ranges A, B, and C in FIG. 17 are basically similar to the ranges A, B, and C in FIG. 14, and thus a description thereof will be omitted. A difference is that the focus position for the object position calculated based on the defocus amount is maintained before the range in FIG. 17D′, which will be discussed later.

FIG. 16D′ illustrates the state from FIG. 16C, in which the user stops the full-time MF operation and changes it to AF for a person who continues to move toward the close distance. In the range D′ in FIG. 17, since the person continues to move toward the close distance, the ideal focus position for the object position continues to change toward the close distance, and the actual focus position is also able to track it, i.e., the focus is tracked near in-focus.

By applying this embodiment, the focus tracking delay that would occur in the range D in FIGS. 13D and 14 can be improved. This transition occurs from the state in which the full-time MF operation was performed in step S901 in FIG. 9 to the state in which the full-time MF operation has been completed in step S905. In step S906, object movement in the close-distance direction is detected, as described in FIG. 12A. In step S907, the full-time MF operation is being performed in the close-distance direction, which coincides with object movement in the close-distance direction, so step S908 sets the AF trackability improvement state after the focus operation. Then, step S1001 in FIG. 10 determines the AF trackability improvement state after the focus operation. After cancellation determinations from step S1002 to step S1004, a transition prohibition state to a focusing stop state is set in step S1005, and a predictive drive permission state is set in step S1006.

Thereby, through the determination in step S1101 in FIG. 11, processing regarding predictive drive is performed in steps S1102 and S1103. Thus, in AF after a full-time MF operation is completed, focus tracking can be continued using predictive AF based on the focus position for the object position calculated based on the defocus amounts stored in the ranges before the range D′ in FIG. 17, i.e., the movement history information on the person during the MF operation. Furthermore, since a transition prohibition state to a focusing stop state is set in step S1005 in FIG. 10, focus tracking delays caused by transitioning to the focusing stop state can also be suppressed, as described using the range D in FIG. 15.

As to the cancellation processing in steps S1002 to S1004 in FIG. 10, in the case of FIG. 17, even if the defocus amount within the depth of focus is detected for the predetermined time in step S1002, the focus lens position continues to change. Thus, the condition of step S1003 is not met. Thereby, the AF trackability improvement state after the focus operation can be continued.

In a case where a change occurs after the range D′ in FIG. 17, such as the person object stopping or the object changing, the AF tracking improvement state after the focus operation is canceled according to the conditions in steps S1002 to S1004. Thereafter, in a case where the full-time MF operation is performed again, the determination of whether to set the AF tracking improvement state after the focus operation is made again in FIG. 9.

In the description with reference to FIGS. 16A, 16B, 16C, and 16D′, a change in object distance of a person is used as an example, but as in FIGS. 13A, 13B, 13C, and 13D, the object type is not limited to a person and can be any other object as long as the object distance changes. For example, it can be a scene in which an animal is approaching or a scene in which something held by a hand is introduced. This embodiment is not limited to cases in which the object is approaching, but can also be applied to cases in which the object is moving away.

In this embodiment, the control unit 2042 may change the AF trackability after manual focus is completed, according to whether the manual focus direction and the object moving direction are equal to each other (whether both directions are the close-distance direction or the infinity direction). The acquiring unit 2041 may acquire object movement information using the defocus amount and reliability information on the defocus amount acquired from the focus information. The acquiring unit 2041 may determine that the object has moved in a case where the object has moved in one direction of the close-distance direction and the infinity direction for a predetermined time.

In a case where the object moves, the control unit 2042 may improve trackability compared to a case where the object does not move, by making it more difficult to stop the focus lens that is driven in the object moving direction than in a case where the object does not move. After determining to improve trackability, the control unit 2042 may restore trackability (cancels improving trackability) in a case where the focus lens position remains within a predetermined amount for a predetermined period of time and the defocus amount remains within a predetermined amount for a predetermined period of time. After determining to improve trackability, the control unit 2042 may restore trackability in a case where the reliability of the defocus amount becomes lower than a predetermined value.

In a case where the object moves, the control unit 2042 may predict the object movement using past position information on the focus lens and focus information, and making it easier to drive the focus lens than in a case where the object does not move, thereby improving the trackability compared to a case where the object does not move. In a case where the object moves, the control unit 2042 may predict the object movement using past position information on the focus lens and focus information, thereby improves the trackability compared to a case where the object does not move.

As described above, in this embodiment, after a full-time MF operation, it is determined whether to set a AF trackability improvement state after a focus operation. In a case where object movement is detected and the object moving direction and the focusing direction of the full-time MF are the same direction, the AF trackability improvement state after the focus operation is set. In a case where the AF trackability improvement state after the focus operation is set, a transition prohibition state to a focusing stop state is set and a predictive drive permission state is set in the AF after the full-time MF operation. Thereby, focus tracking performance can be improved even when focus tracking on the object is delayed in the AF after the full-time MF operation.

### Second Embodiment

Next, a second embodiment according to the disclosure will be described. This embodiment will omit a description of components similar to those in the first embodiment.

### Details of Various Processing Performed by Camera Unit 20

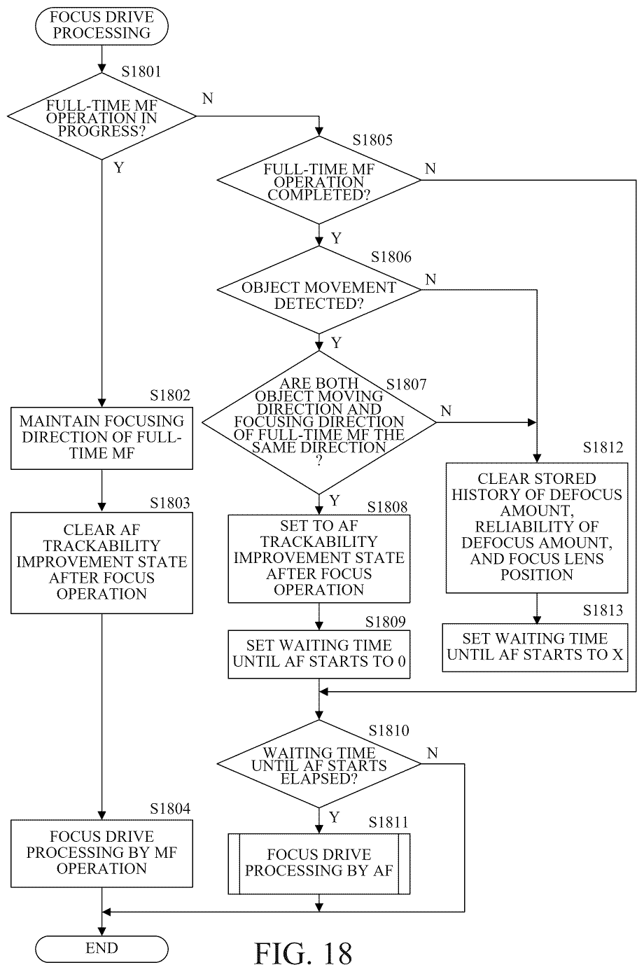

In this embodiment, the camera unit 20 performs the focus drive processing of step S710 in FIG. 7, as illustrated in FIG. 18. FIG. 18 is a flowchart illustrating the focus drive processing in this embodiment. The processing of steps S1801 to S1808, S1811, and S1812 in FIG. 18 is similar to the processing of steps S901 to S910 in FIG. 9, respectively, and a detailed description thereof will be omitted.

In step S1809 in FIG. 18, under the condition that the AF trackability improvement state after the focus operation is set in step S1808, the camera control unit 204 sets the waiting time until AF starts to 0 and the flow proceeds to step S1810.

In step S1810, the camera control unit 204 determines whether the waiting time until AF starts has elapsed. In a case where the waiting time has elapsed, the flow proceeds to step S1811, where focus drive processing by AF is executed. On the other hand, in a case where the waiting time has not elapsed, the focus drive processing by AF in step S1811 is not executed, and the focus drive processing is terminated.

In step S1813, under the condition that the AF trackability improvement state after the focus operation is not set, the camera control unit 204 sets the waiting time until AF starts to X, and the flow proceeds to step S1813. This waiting time X is set to a value greater than 0.

In this embodiment, the camera control unit 204 sets a waiting time when executing the AF processing after the full-time MF operation, and delays the AF start during the set waiting time. In setting the AF trackability improvement state after the focus operation, the waiting time is set to 0; otherwise, the waiting time is set to X greater than 0.

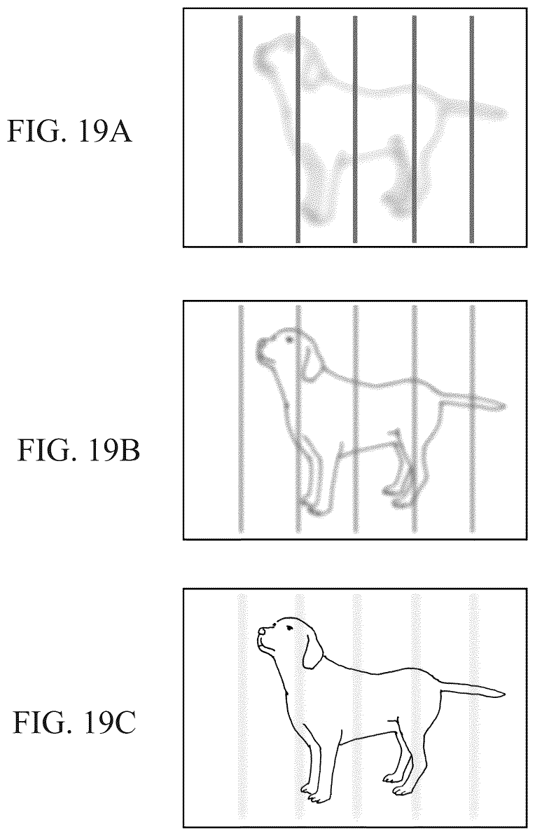

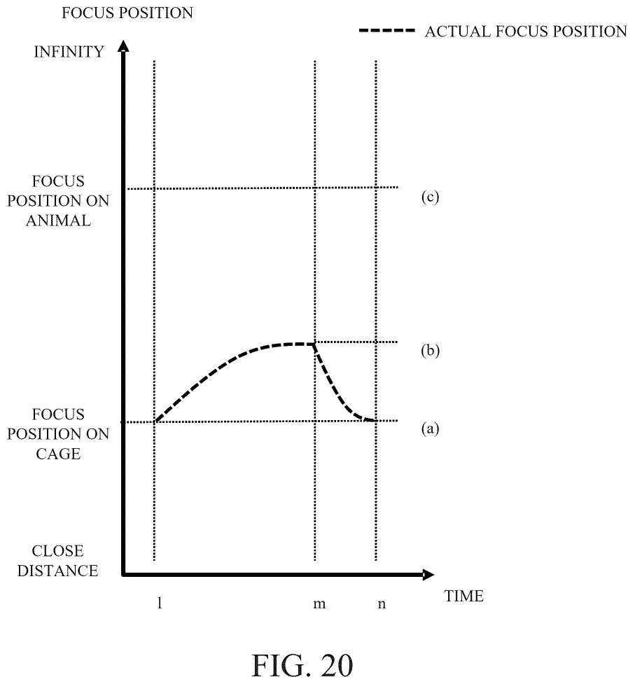

Referring now to FIGS. 19A, 19B, 19C and 20, a description will be given of the cases where it is better to have a waiting time before the AF processing after the full-time MF operation is executed. FIGS. 19A, 19B, and 19C illustrate an example of a case where it is better to have a waiting time before the AF processing after the full-time MF operation is executed.

FIGS. 19A, 19B, 19C and 20 illustrate an imaging scene with an animal in a cage. FIG. 19A illustrates a state in which the cage is in focus and the animal is out of focus. FIG. 19B illustrates a state in which an in-focus position is located at an intermediate position between the cage and the animal, and both the cage and the animal are out of focus. FIG. 19C illustrates a state in which the animal is in focus and the cage is out of focus. FIG. 20 illustrates a change example of the actual focus position when the full-time MF operation is started and stopped for the scenes in FIGS. 19A, 19B, and 19C. In FIG. 20, the vertical axis represents a focus position, illustrating the focus positions where the cage and the animal are in focus. The focus position where the cage is in focus corresponds to the state in FIG. 19A, and the focus position where the animal is in focus corresponds to the state in FIG. 19C. Furthermore, there is a state corresponding to FIG. 19B between the focus position where the cage is in focus and the focus position where the animal is in focus. In FIG. 20, the horizontal axis represents time, and the transition of the focus position will be described below by addressing times l, m, and n.

A case for using full-time MF includes an example of focus tracking on an approaching or departing object, as illustrated in FIGS. 13A, 13B, 13C, 13D, 16A, 16B, 16C, 16D′, but FIGS. 19A, 19B, and 19C illustrate an example of a different use case. Although both the cage and animal in FIGS. 19A, 19B, and 19C do not include any object approaching or moving away and the user actually wishes to focus on the animal, the AF processing may end up focusing on the cage located at a close distance. In this case, one method to refocus from the cage to the animal is to use full-time MF to change the focus position.

Time 1 in FIG. 20 illustrates a state when full-time MF operation is started toward the animal, i.e., in the infinity direction, from a state where the cage is in focus, as illustrated in FIG. 19A. However, during a full-time MF operation, if a large amount necessary for rotation of the focus ring on the lens operation unit 112 is required, a single full-time MF operation may not result in the animal being in focus, as illustrated in FIG. 19C. FIG. 20 assumes such a case at time m, and illustrates the state where the first full-time MF operation is stopped and the cage and the animal are temporarily in focus, as illustrated in FIG. 19B. From this state, it is possible to approach the state of FIG. 19C from the state of FIG. 19B by preparing for a second full-time MF operation and re-rotating the focus ring on the lens operation unit 112.

However, in a case where AF processing operates while preparations are being made to re-rotate the focus ring after time m, the state of FIG. 19B may return to the state of FIG. 19A, where the cage is in focus. Time n illustrates the state where the cage is in focus again, as illustrated in FIG. 19A, as described above, due to AF processing. To avoid this problem, a waiting time is provided after a full-time MF operation before AF processing is started, and thereby the focus position is prevented from being immediately returning to the state in FIG. 19A, as shown from time m to n in FIG. 20. Thus, in a case where the object is not moving in the depth direction and it is desired to change from a specific object to another, a waiting time may be provided after a full-time MF operation before AF processing is started.

Steps S1810 and S1813 in FIG. 18 are processing based on this type of case. The waiting time X set in step S1813 can be determined, for example, based on the time until another full-time MF operation is performed after a full-time MF operation.

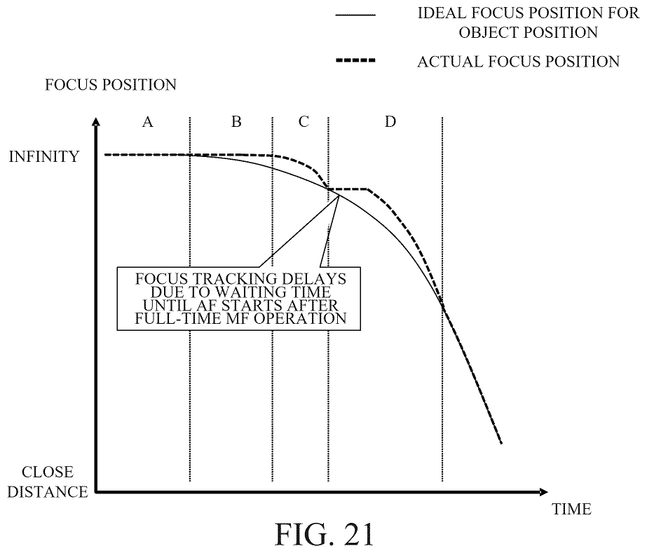

On the other hand, in the case of scenes that pose a problem in this embodiment, such as those illustrated in FIGS. 13A, 13B, 13C, and 13D, where an object is moving in the depth direction, a waiting time may not be provided before AF starts after a full-time MF operation as described above. FIG. 21 illustrates an example of the ideal and actual focus positions for the object position in each of the scenes illustrated in FIGS. 13A, 13B, 13C, and 13D, with a waiting time before AF starts after a full-time MF operation. Ranges A, B, and C in FIG. 21 are the same as the ranges A, B, and C in FIG. 14 described in the first embodiment, and thus a description thereof will be omitted.

A range D in FIG. 21 represents the state in which AF processing is set after a full-time MF operation is performed to focus on the object in the range C in FIG. 21. In a case where the start of AF processing is delayed by the waiting time set in step S1813 in FIG. 18, it will be impossible to immediately track the focus on an approaching object, as in the range D in FIG. 21. In this embodiment, even if a system delays the start of AF processing after a full-time MF operation, if object movement is detected in step S1806 in FIG. 18, it is determined in step S1807 whether the object moving direction and the focusing direction of the full-time MF are the same direction. In a case where this condition is met, i.e., in a case where it is assumed that an object moving in the depth direction is being tracked using full-time MF, then in step S1809, the waiting time before AF starts after full-time MF operation is set to 0.

In this embodiment, the control unit 2042 may reduce the waiting time until AF starts in a case where the object is moving, thereby improving trackability compared to a case where the object is not moving.

As a result, similarly to the first embodiment, this embodiment enables proper focus tracking on an object moving in the depth direction in AF processing after a full-time MF operation. In this embodiment, the waiting time until AF starts is set to 0 in step S1809, but the waiting time does not have to be 0 as long as it is shorter than the time X set in step S1813.

### Third Embodiment

Next, a third embodiment according to the disclosure will be described. A description of components similar to those in the first embodiment will be omitted.

### Configuration of Image Pickup Apparatus

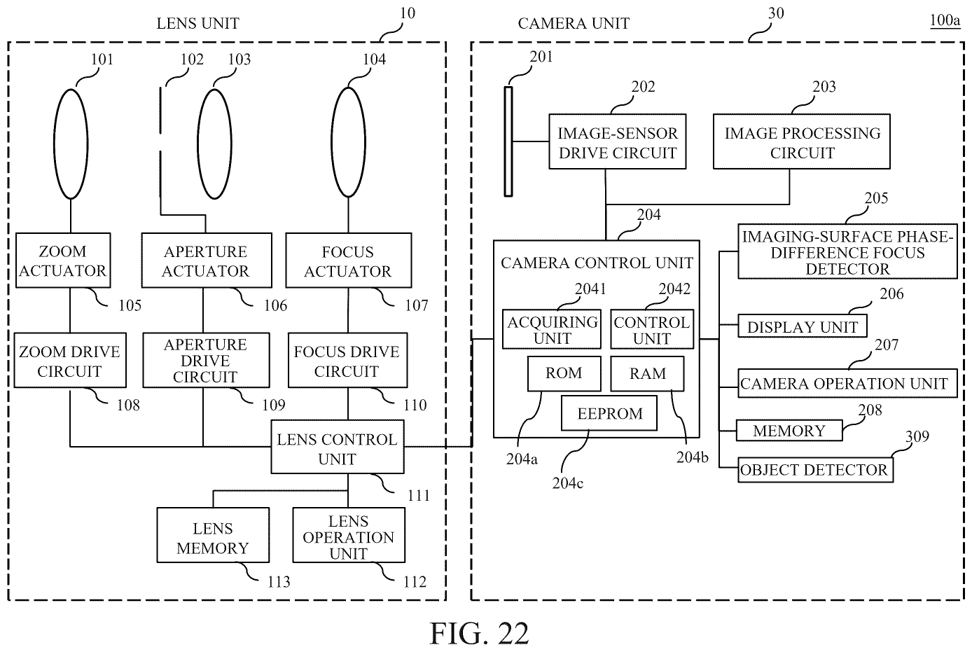

Referring now to FIG. 22, a description will be given of an example of the functional configuration of a digital camera 100a as an example of an image pickup apparatus according to this embodiment. FIG. 22 is a block diagram of digital camera (image pickup apparatus) 100a. The digital camera 100a includes the lens unit 10 and a camera unit 30. In FIG. 22, the lens unit 10 and its internal configuration are similar to those of the lens unit 10 and its internal configuration in FIG. 1, and thus a detailed description thereof will be omitted. Reference numerals 201 to 208 of the camera unit 30 in FIG. 22 are similar to reference numerals 201 to 208 of the camera unit 20 in FIG. 1, and thus a detailed description thereof will be omitted.

The camera unit 30 in the digital camera 100a differs from the camera unit 20 in the digital camera 100 in that it includes an object detector 309. The camera control unit 204 controls the object detector 309 to communicate information.

The object detector 309 detects an object based on image data obtained by the image processing circuit 203. The camera control unit 204 uses object detection that estimates where a target object is located in image data, to select a focusing result by the imaging-surface phase-difference focus detector 205, which drives the focus lens 104 via the lens control unit 111. Objects to be detected include, for example, a person's face and his pupils, an animal's torso and its face/pupils, and the entire vehicle and its characteristic parts (such as a driver or cockpit of the vehicle). Object movement can be detected from information on various parts, such as not only a person's face, torso, arm, and leg, as well as its position and shape. For example, it is possible to determine whether a person is running based on the posture of the arms and legs held forward and backward. An object present at a position specified by the user on the imaging screen is detected via a user touch operation on the display unit 206. Various information on object detection, such as the size of the detected object, is also used to control the camera control unit 204.

### Details of Various Processing Performed by Camera Unit 30

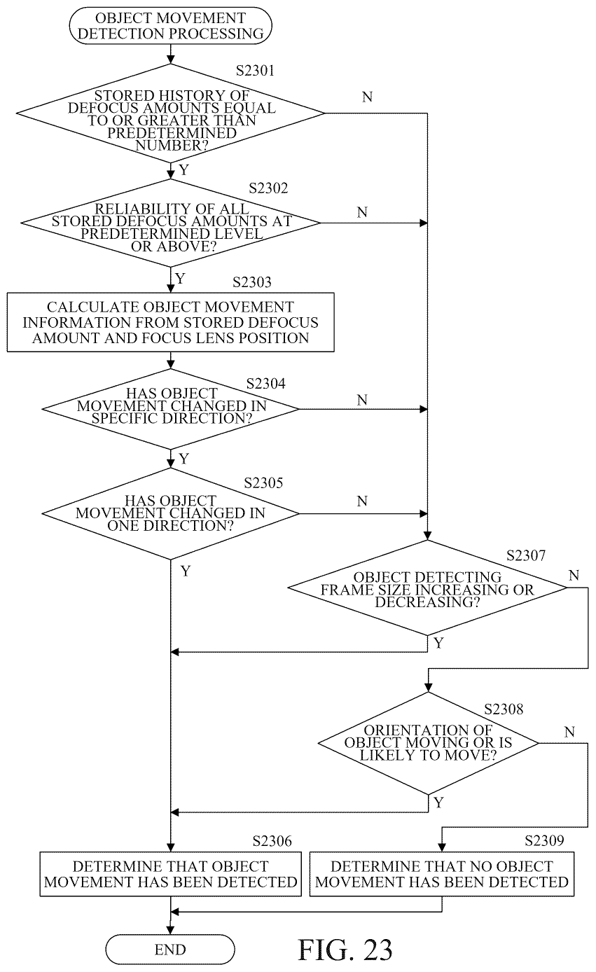

In this embodiment, the object movement detection processing in step S709 of FIG. 7 follows the flowchart illustrated in FIG. 23. FIG. 23 is a flowchart illustrating the object movement detection processing in this embodiment. Steps S2301-S2306 and S2309 in FIG. 23 are similar to steps S801-S807 of FIG. 8, respectively, and thus a detailed description thereof will be omitted.

In step S2307 of FIG. 23, the camera control unit 204 determines whether the object detecting frame size is increasing or decreasing based on information from the object detector 309. In a case where the object detecting frame size is continuously increasing or decreasing, the flow proceeds to step S2306. Otherwise, the flow proceeds to step S2308.

In step S2308, the camera control unit 204 determines whether the orientation of the object is moving or is likely to move based on information from the object detector 309. In a case where the object is moving or has an orientation that is likely to move, the flow proceeds to step S2306. On the other hand, otherwise, the flow proceeds to step S2309.

In this embodiment, the object movement detection processing uses information from the object detector 309 (behavior (or action) information of an object) in addition to the change in the defocus amount in steps S2301 to S2305. In a case where the object detecting frame size is increasing or decreasing in step S2307, the object may be approaching or moving away. In such a case, it is determined in step S2306 that object movement has been detected. In step S2308, it is determined whether the orientation of the object is moving or is likely to move. If this is the case, it is also determined in step S2306 that object movement has been detected. Examples of the object orientation that is moving include a running posture and a posture in which a soccer or basketball player is dribbling. Examples of the object orientation that is likely to move include a crouching start posture in which the object is about to start running. If such a posture or action is detected, it is determined in step S2306 that object movement has been detected. On the other hand, if a posture is detected in which no or only minimal movement occurs in the depth direction, such as a shooting posture in a soccer or basketball game or a sitting posture of an animal, it is determined that the object movement is not detected in step S2309.

In this embodiment, the acquiring unit 2041 may acquire object movement information using information on changes in the object size. The acquiring unit 2041 may acquire object movement information using behavior (or action) information of the object.

### Fourth Embodiment

A fourth embodiment according to the disclosure will be described below. A description of components similar to those in the first embodiment will be omitted.

### Details of Various Processing Performed by Camera Unit 20

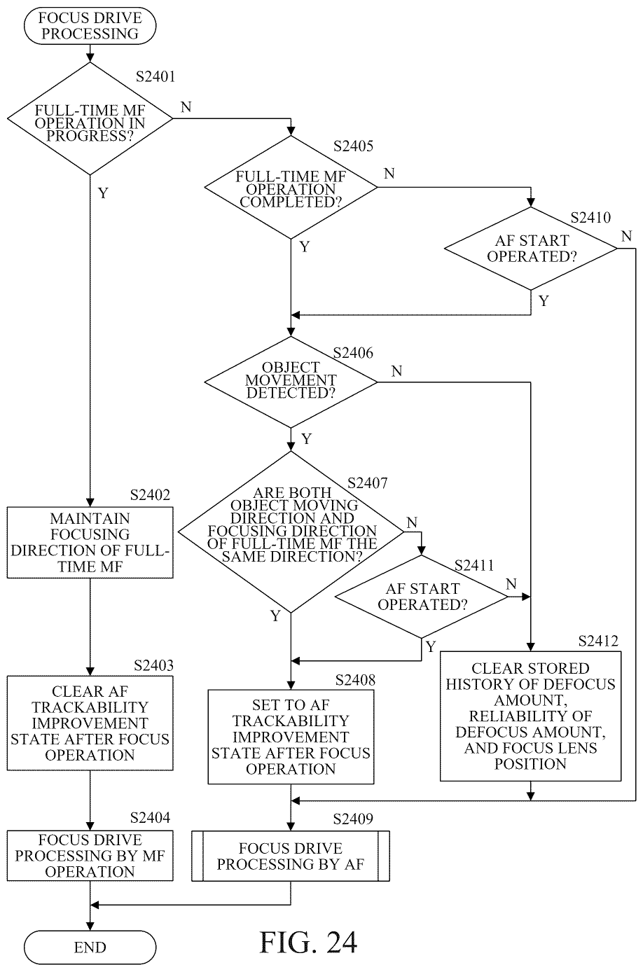

In this embodiment, the focus drive processing in step S710 of FIG. 7 follows the flowchart in FIG. 24. FIG. 24 is a flowchart illustrating focus drive processing according to this embodiment. Steps S2401 to S2809 and S2812 in FIG. 24 are similar to steps S901 to S910 in FIG. 9, respectively, and thus a detailed description thereof will be omitted.

In step S2410 of FIG. 24, the camera control unit 204 determines whether or not an AF (execution) start operation has been performed. In a case where the AF start operation has been performed, the flow proceeds to step S2406. On the other hand, in a case where the AF start operation has not been performed, the flow proceeds to step S2409. The AF start operation indicates that the focusing start switch of the camera operation unit 207 in the camera unit 20 has been pressed, and an AF start instruction has been issued by the user operation.

In step S2411, the camera control unit 204 determines whether or not the AF start operation has been performed, as in step S2410. In a case where the AF start operation has been performed, the flow proceeds to step S2408. On the other hand, in a case where the AF start operation has not been performed, the flow proceeds to step S2412.

In this embodiment, even when the user performs an AF start operation rather than a full-time MF operation, if object movement is detected in step S2406, the AF trackability improvement state after a focus operation is set in step S2408. However, unlike the full-time MF operation, the AF start operation generally cannot specify a direction in which the focus lens 104 is to be driven. Therefore, as in step S2407, it is not possible to determine whether the object moving direction and the desired direction in which the focus lens 104 is to be driven are equal to each other. Thus, in a case where the AF start operation is performed, in step S2411, the AF trackability improvement state after the focus operation is set in step S2408, regardless of the condition in step S2407.

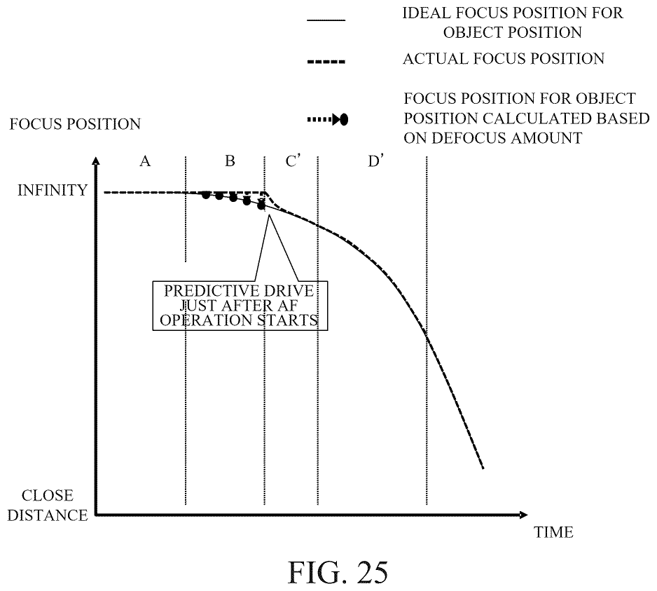

FIG. 25 illustrates the ideal focus position and actual focus position for the object position in each of the scenes in FIGS. 16A, 16B, 16C, and 16D′ in a case where the AF start operation is performed in this embodiment.

FIGS. 16A, 16B, 16C, and 16D′ correspond to ranges A, B, C′, and D′ in FIG. 25, respectively. Ranges A, B, and D′ in FIG. 25 are basically similar to the ranges A, B, and D′ in FIG. 17 in the first embodiment, and thus a description thereof will be omitted.

In this embodiment, FIG. 16C represents a state where the user performs an AF start operation, following the state in FIG. 16B where a person has started to move toward the close distance and AF tracking is delayed. In the range B in FIG. 25, the object movement has already been detected based on the focus position for the object position calculated based on the defocus amount. When the user performs an AF start operation at the timing of the transition from B to C′ in FIG. 25, it is determined in step S2410 in FIG. 24 that an AF start operation has been performed. As described above, the object movement has already been detected, so the flow proceeds from step S2406 to step S2407.

In step S2407, a full-time MF operation has not been performed, and it is not possible to determine whether the focusing direction of MF and the object moving direction are equal to each other. Thus, the flow proceeds to step S2411. In a case where an AF start operation is performed, it is not determined that both directions are equal to each other, and the flow proceeds to step S2408 to set an AF trackability improvement state after a focus operation. Thereby, in the range C′ in FIG. 25, the actual focus position catches up with the ideal focus position for the object position at an early stage, the focus tracking is quickly recovered from delay, and AF trackability can be improved. Even if an AF start operation is performed and an AF trackability improvement state after a focus operation is set in step S2408, the AF processing continues even if the AF start operation is canceled. Therefore, in a case where the conditions for clearing the AF trackability improvement state after the focus operation are not met by the processing of steps S1002 to S1004 and S1007 in FIG. 10, the AF trackability improvement state is maintained regardless of whether the AF start operation is ongoing or has been stopped.

In this embodiment, the acquiring unit 2041 may acquire object movement information in a case where the second operation unit (the focusing start switch of the camera operation unit 207) that instructs the AF start is operated. In a case where the second operation unit is operated, the control unit 2042 may change the AF trackability in accordance with the object movement information.

As discussed above, unlike a full-time MF operation, an AF start instruction generally cannot set a desired moving direction of the focus lens 104. Thus, it is not possible to determine whether the object moving direction and the desired AF direction match. Therefore, the AF trackability improvement state after the full-time MF operation is higher in terms of the accuracy of the coincidence degree between the object moving direction and the focus lens drive direction than the AF trackability improvement due to an AF start instruction. On the other hand, the AF start instruction is easy to use because it is completed with AF without performing the MF operation, which requires a certain level of skill.

If there is a function that can determine a moving direction of the focus lens 104 in instructing an AF start, the accuracy can be improved by considering the drive direction of the focus lens as a condition for improving AF trackability. For example, the processing of step S2411 in FIG. 24 can be omitted, and control may be performed in step S2407 to check whether not only the focusing direction of the full-time MF but also the AF direction at the AF start matches the object moving direction.

Each embodiment can improve AF trackability. Therefore, each embodiment can provide a control apparatus, an image pickup apparatus, a control method, and a storage medium, each of which can achieve proper AF.

### OTHER EMBODIMENTS

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-220266, which was filed on Dec. 16, 2024, and which is hereby incorporated by reference herein in its entirety.

What is claimed is:

1. A control apparatus comprising:
one or more memories storing instructions; and
one or more processors that, upon execution of the instructions, operate to:
acquire movement information on an object,
control a focus lens using focus information acquired from an imaging signal, and
change processing regarding trackability in autofocus according to the movement information on the object.

2. The control apparatus according to claim 1, wherein the movement information includes information on whether the object has moved,
wherein the one or more processors operate to change the processing regarding the trackability in a case where the object has moved.

3. The control apparatus according to claim 2, wherein a moving direction of the object viewed from an image pickup apparatus is a close-distance direction or an infinity direction.

4. The control apparatus according to claim 1, wherein the one or more processors operate to acquire the movement information on the object in a case where a first operation unit for manual focus is operated.

5. The control apparatus according to claim 4, wherein the one or more processors operate to change the trackability in the autofocus after the manual focus by the first operation unit is completed, according to whether both of a focusing direction in the manual focus by the first operation unit and a moving direction of the object viewed from an image pickup apparatus are a close-distance direction or an infinity direction.

6. The control apparatus according to claim 1, wherein the one or more processors operate to acquire the movement information on the object in a case where a second operation unit that instructs a start of the autofocus is operated.

7. The control apparatus according to claim 6, wherein the one or more processors operate to change the trackability in the autofocus according to the movement information on the object in a case where the second operation unit is operated.

8. The control apparatus according to claim 1, wherein the one or more processors operate to acquire the movement information on the object using information on a defocus amount and reliability of the defocus amount acquired from the focus information.

9. The control apparatus according to claim 1, wherein the one or more processors operate to acquire the movement information on the object using information on changes in a size of the object.

10. The control apparatus according to claim 1, wherein the one or more processors operate to acquire the movement information on the object using behavior information on the object.

11. The control apparatus according to claim 1, wherein the one or more processors operate to determine that the object has moved in a case where the object has moved in one of a close-distance direction and an infinity direction for a predetermined period of time.

12. The control apparatus according to claim 1, wherein in a case where the object has moved, the one or more processors operate to make it more difficult to stop the focus lens that is driven in a moving direction of the object viewed from an image pickup apparatus, which is one of a close-distance direction and an infinity direction, than in a case where the object has not moved.

13. The control apparatus according to claim 1, wherein in a case where the object moves, the one or more processors operate to predict movement of the object using past position information on the focus lens and the focus information.

14. The control apparatus according to claim 1, wherein in a case where the object has moved, the one or more processors operate to reduce a waiting time until the autofocus starts.

15. The control apparatus according to claim 1, wherein the one or more processors operate to:
determine that the trackability is to be improved, and
after determining, operate to restore the trackability, in a case where a position of the focus lens is within a predetermined amount for a predetermined time and a defocus amount is within a predetermined amount for a predetermined time, or in a case where reliability of the defocus amount becomes lower than a predetermined value.

16. An image pickup apparatus comprising:
a control apparatus; and
an image sensor,
wherein the control apparatus includes:
one or more memories storing instructions; and
one or more processors that, upon execution of the instructions, operate to:
acquire movement information on an object,
control a focus lens using focus information acquired from an imaging signal, and
change processing regarding trackability in autofocus according to the movement information on the object.

17. A control method comprising:
acquiring movement information on an object;
controlling a focus lens using focus information acquired from an imaging signal; and
changing processing regarding trackability in autofocus according to the movement information on the object in controlling the focus lens.

18. A non-transitory computer-readable storage medium storing a program that causes a computer to execute the control method according to claim 17.
